(19) United States
(12) Patent Application Publication
(10) Pub. No.: US 2024/0373338 A1
(43) Pub. Date: Nov. 7, 2024

(54) CELL STATE DETERMINING METHOD AND APPARATUS

(71) Applicant: FUJITSU LIMITED, Kawasaki-shi Kanagawa (JP)

(72) Inventors: Meiyi JIA, Beijing (CN); Lei ZHANG, Beijing (CN)

(73) Assignee: FUJITSU LIMITED, Kawasaki-shi Kanagawa (JP)

(21) Appl. No.: 18/777,740

(22) Filed: Jul. 19, 2024

Related U.S. Application Data
(63) Continuation of application No. PCT/CN2022/074840, filed on Jan. 28, 2022.

(51) Int. Cl. H04W 48/18; H04W 48/10; H04W 88/04

(52) U.S. Cl. CPC H04W 48/18; H04W 48/10; H04W 88/04

(57) ABSTRACT

A cell state determining apparatus, applicable to a Network-Controlled repeater (NCR), includes: a receiver configured to receive relevant information of cell selection or reselection, and processor circuitry configured to consider a cell as a candidate for cell selection for Network-Controlled repeater according to the relevant information of cell selection or reselection, and/or, ignore the relevant information of cell selection or reselection.

### CROSS-REFERENCE TO RELATED APPLICATION

This application is a continuation application of International Application PCT/CN2022/074840 filed on Jan. 28, 2022, and designated the U.S., the entire contents of which are incorporated herein by reference.

### FIELD

This disclosure relates to the field of communication technologies.

### BACKGROUND

Compared with traditional 3G (third generation mobile communication technology) and 4G (fourth generation mobile communication technology) systems, a 5G (fifth generation mobile communication technology) system is able to provide larger bandwidths and higher data rates, and is able to support more types of terminals and vertical services. For this reason, a deployment frequency of a 5G system is obviously higher than those of 3G and 4G systems. For example, a 5G system may be deployed in a millimeter waveband.

However, the higher a carrier frequency, the more severe a fading experienced by signals during transmission. Therefore, in actual deployment of a 5G system, especially in the millimeter waveband, how to better enhance cell coverage has become an urgent problem to be solved.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

In order to better solve the coverage problem of cellular mobile communication systems in practical deployment, use of a radio frequency (RF) repeater to amplify and forward signals between a terminal equipment and a network device is commonly used means of deployment. RF repeaters are widely used in actual deployment of 3G and 4G systems. Generally speaking, an RF repeater is a device that amplifies and forwards signals between a network device and a terminal equipment in the RF domain.

One of feasible solutions to address the coverage problem encountered in the deployment of 5G systems is to use RF repeaters for coverage enhancement. However, traditional repeaters do not have the ability to communicate with network devices and are unable to obtain information of uplink and downlink configurations from the network devices. Therefore, deploying such repeaters in 5G systems, although it is helpful to enhancement of signal strengths, is not flexible enough to cope with complex environmental changes, and thus unable to achieve the same effects as deploying the same RF repeaters in 3G and 4G systems.

A smart repeater is enhancement of a traditional RF repeater, and has the ability to receive and process side control information from a network. The side control information allows the smart repeater to perform its amplification and forwarding operations in a more efficient manner. Hence, unnecessary noise amplification may be reduced, transmission and reception having better spatial directionality may be provided, and network integration may be simplified.

However, it was found by the inventors that for a scenario where a smart repeater is deployed, when the smart repeater performs cell selection and/or reselection, there is currently no method for cell state determining by the smart repeater.

In order to solve at least one of the above problems, embodiments of this disclosure provide a cell state determining method and apparatus.

According to one aspect of the embodiments of this disclosure, there is provided a cell state determining method, applicable to a repeater, the method including:
receiving relevant information of cell selection or reselection; and
determining whether a cell can be considered as a candidate cell of the repeater in a cell selection or reselection procedure according to the relevant information of cell selection or reselection.

According to another aspect of the embodiments of this disclosure, there is provided a cell state determining method, applicable to a network device, the method including:
generating relevant information of cell selection or reselection, the relevant information of cell selection or reselection being used by a repeater to determine whether a cell can be considered as a candidate cell of the repeater in a cell selection or reselection procedure; and
transmitting the relevant information of cell selection or reselection.

According to a further aspect of the embodiments of this disclosure, there is provided a cell state determining method, applicable to a terminal equipment, the method including:
receiving relevant information of cell selection or reselection; and
ignoring repeater-specific relevant information of cell selection or reselection in the relevant information of cell selection or reselection.

In order to solve at least one of the above problems, embodiments of this disclosure provide a cell state determining apparatus, applicable to a repeater, the apparatus including:
a receiving unit configured to receive relevant information of cell selection or reselection; and
a determining unit configured to determine whether a cell can be considered as a candidate cell of the repeater in a cell selection or reselection procedure according to the relevant information of cell selection or reselection.

According to still another aspect of the embodiments of this disclosure, there is provided a cell state determining apparatus, applicable to a network device, the apparatus including:
a generating unit configured to generate relevant information of cell selection or reselection, the relevant information of cell selection or reselection being used by a repeater to determine whether a cell can be considered as a candidate cell of the repeater in a cell selection or reselection procedure; and
a transmitting unit configured to transmit the relevant information of cell selection or reselection.

According to yet another aspect of the embodiments of this disclosure, there is provided a cell state determining apparatus, applicable to a terminal equipment, the apparatus including:
a receiving unit configured to receive relevant information of cell selection or reselection; and
a determining unit configured to ignore repeater-specific relevant information of cell selection or reselection in the relevant information of cell selection or reselection.

An advantage of the embodiments of this disclosure exists in that the repeater may determine a candidate cell in the cell selection or reselection procedure, thereby ensuring flexible deployment of a smart repeater, and lowering deployment costs.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the spirits and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiments.

FIG. 1 is a schematic diagram of an application scenario of an embodiment of this disclosure;

FIG. 2 is a schematic diagram of receiving and transmitting signals by a repeater of an embodiment of this disclosure;

FIG. 3 is another schematic diagram of receiving and transmitting signals by the repeater of the embodiment of this disclosure;

FIG. 4 is a schematic diagram of a cell state determining method of an embodiment of this disclosure;

FIG. 5 is a schematic diagram of a cell state determining method of an embodiment of this disclosure;

FIG. 6 is a schematic diagram of a cell state determining method of an embodiment of this disclosure;

FIG. 7 is a schematic diagram of a cell state determining apparatus of an embodiment of this disclosure;

FIG. 8 is a schematic diagram of a cell state determining apparatus of an embodiment of this disclosure;

FIG. 9 is a schematic diagram of a cell state determining apparatus of an embodiment of this disclosure;

FIG. 10 is a schematic diagram of a network device of an embodiment of this disclosure;

FIG. 11 is a schematic diagram of a repeater of an embodiment of this disclosure; and

FIG. 12 is a schematic diagram of a terminal equipment of an embodiment of this disclosure.

### DETAILED DESCRIPTION OF THE DISCLOSURE

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the spirit and terms of the appended claims.

In the embodiments of this disclosure, terms “first”, and “second”, etc., are used to differentiate different elements with respect to names, and do not indicate spatial arrangement or in temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, and 5G and new radio (NR) in the future, etc., and/or other communication protocols that are currently known or will be developed in the future.

In the embodiments of this disclosure, the term “network device”, for example, refers to a device in a communication system that accesses a user equipment to the communication network and provides services for the user equipment. The network device may include but not limited to the following devices: a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), etc. Furthermore, it may include a remote radio head (RRH), a remote radio unit (RRU), a relay or a low-power node (such as a femto, and a pico, etc.), and an IAB (integrated access and backhaul) node or an IAB-DU or an IAB-donor. The term “base station” may include some or all of its functions, and each base station may provide communication coverage for a specific geographical area. And a term “cell” may refer to a base station and/or its coverage area, depending on a context of the term. Without causing confusion, “a cell” and “a base station” are interchangeable.

In the embodiments of this disclosure, the term “user equipment (UE)” or “a terminal equipment (TE) or a terminal device” refers to, for example, an equipment accessing to a communication network and receiving network services via a network device. The terminal equipment may be fixed or mobile, and may also be referred to as a mobile station (MS), a terminal, a subscriber station (SS), an access terminal (AT), an IAB-MT, or a station, etc.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the user equipment may also be a machine or a device performing monitoring or measurement. For example, it may include but not limited to a machine-type communication (MTC) terminal, a vehicle mounted communication terminal, a device to device (D2D) terminal, and a machine to machine (M2M) terminal, etc.

Moreover, the term “network side” or “network device side” refers to a side of a network, which may be a base station or a core network device, and may include one or more network devices described above. The term “user side” or “terminal side” or “terminal equipment side” refers to a side of a user or a terminal, which may be a UE, and may include one or more terminal equipment described above. In this text, “a device” may refer to a network device, or may refer to a terminal equipment, except specified otherwise.

Scenarios of the embodiments of this disclosure shall be described below by way of examples; however, this disclosure is not limited thereto.

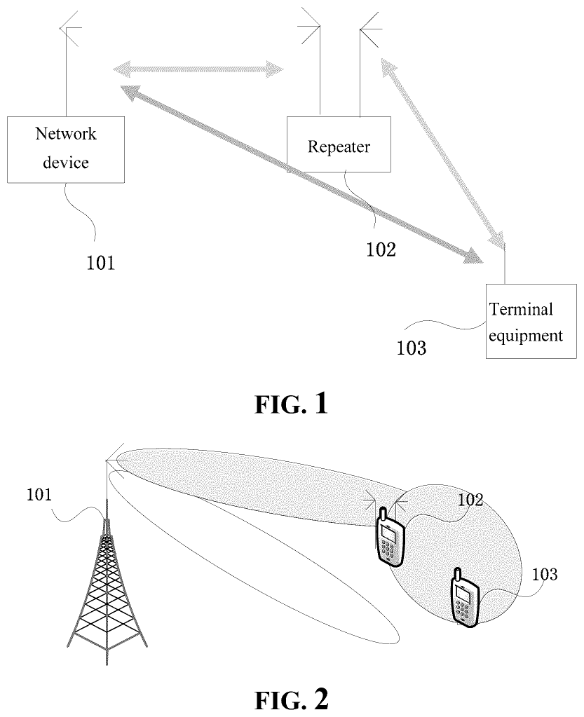

FIG. 1 is a schematic diagram of an application scenario of an embodiment of this disclosure. As shown in FIG. 1, for the sake of description, the description shall be given by taking a network device (such as a 5G gNB or gNB-CU) 101, a repeater 102 and a terminal equipment (UE) 103 as examples; however, this disclosure is not limited thereto. As shown in FIG. 1, the terminal equipment 103 may establish connection with the network device 101 and communicate therewith. In order to improve communication quality, signals between the terminal equipment 103 and the network device 101 may be processed (such as being amplified) via the repeater 102.

As shown in FIG. 1, radiated or conducted RF carriers are received, processed and transmitted in a downlink direction (from a network device to a terminal equipment) and an uplink direction (from the terminal equipment to the network device). The processing includes power amplification (amplify), beamforming, and reshaping a propagation environment, etc. In an operating frequency band where only downlink or uplink is designated, only the designated uplink or downlink is repeated.

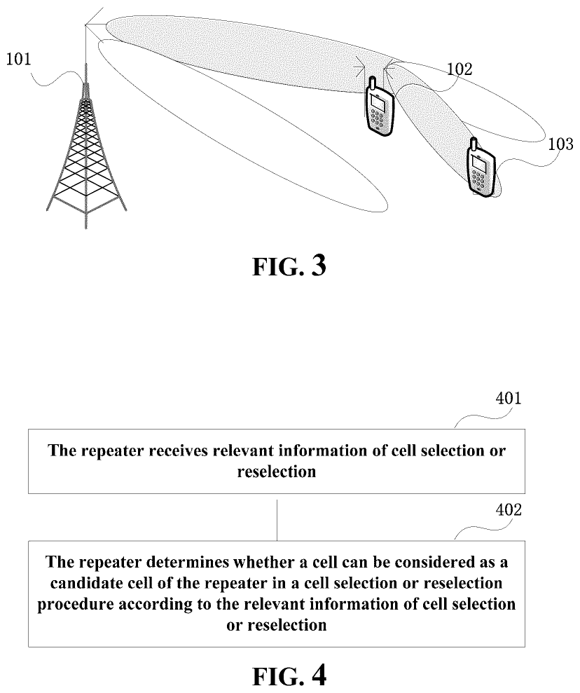

FIGS. 2 and 3 are schematic diagrams of receiving and transmitting signals by a repeater. As shown in FIG. 2, the repeater includes an omnidirectional or fixed-direction (non-adaptive along with the time) Tx/Rx repeater or a repeater with an adaptive ability along with the time. As shown in FIG. 3, beams for transferring RF signals are controlled by the network device (such as an RAN node).

In the embodiments of this disclosure, existing traffics or traffics that may be implemented in the future may be performed between the network device and the terminal equipment. For example, such traffics may include but not limited to enhanced mobile broadband (eMBB), massive machine type communication (mMTC), ultra-reliable and low-latency communication (URLLC), and Vehicle to Everything (V2X), etc.

Description in FIG. 1 is given by taking that the repeater is able to forward signals between the network device and the terminal equipment as an example; however, this disclosure is not limited thereto. For example, a repeater may act as a second device and forward signals between a first device and a third device, and is able to communicate directly with the first device and/or the third device. The first device, the second device and the third device may be any devices in the above-described network. In the following embodiments, description shall be given by taking that the first device is a network device and the third device is a terminal equipment as an example.

In the embodiments of this disclosure, the beam may also be expressed as a lobe, a reference signal (RS), a transmission configuration indication (TCI), and a spatial domain filter, etc., or, it may also be expressed as a beam index, a lobe index, a reference signal index, a transmission configuration indication index, and a spatial filter index, etc. The reference signal is, for example, a channel state information reference signal (CSI-RS), a sounding reference signal (SRS), an RS used by a repeater, and an RS transmitted by a repeater, etc. The TCI may also be expressed as a TCI state.

In the embodiments of this disclosure, the repeater may also be expressed as a network controlled repeater (NCR), or a reconfigurable intelligent surface (RIS), a repeater station, or a relay, or a radio frequency repeater, or a radio frequency relay; or, it may also be expressed as a repeater station node, a relay node; or, it may also be expressed as a repeater node, a relay node; or, it may also be expressed as an intelligent repeater station, an intelligent relay, an intelligent repeater node, and an intelligent relay node, etc. The repeater may be a node, or a device, or an entity, etc., and this disclosure is not limited thereto.

In the embodiments of this disclosure, the network device may be a device of a serving cell of a terminal equipment, or may also be a device of a cell where the repeater is located, or a device of a serving cell of the repeater, or a parent node of the repeater. Names of the repeater are not limited in this disclosure, and any device capable of achieving the above functions is included in the scope of the repeater of this disclosure.

At present, a terminal equipment will receive system information broadcast by a network device, the system information containing relevant information for cell selection and/or reselection. The terminal equipment may determine whether a cell state is barred or allowed, or reserved or not reserved according to the information. For a scenario where a smart repeater is deployed, when the smart repeater performs cell selection and/or reselection, if some cell states are configured as being barred or reserved, for example, according to behaviors of an existing terminal equipment, the repeater is unable to select such a cell to camp on, which limits application scenarios of the repeater and increases deployment costs.

Addressed to the above problems, this disclosure shall be described below with reference to various implementations of the embodiments. These implementations are illustrative only and are not intended to limit this disclosure.

### Embodiments of a First Aspect

The embodiments of this disclosure provides a cell state determining method, which shall be described from a repeater.

FIG. 4 is a schematic diagram of the cell state determining method of the embodiment of this disclosure. As shown in FIG. 4, the method includes:
401: the repeater receives relevant information of cell selection or reselection; and
402: the repeater determines whether a cell can be considered as a candidate cell of the repeater in a cell selection or reselection procedure according to the relevant information of cell selection or reselection.

Hence, the repeater may determine a candidate cell in the cell selection or reselection procedure according to the relevant information of cell selection or reselection, thereby ensuring flexible deployment of a smart repeater, and lowering deployment costs.

It should be noted that FIG. 4 only schematically illustrates the embodiments of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 4.

For ease of understanding, the cell selection and reselection procedure shall be schematically described below.

In some embodiments, when the repeater performs the cell selection and/or cell reselection procedure, control information from the network device may be received by the repeater or a specific module in the repeater, such as receiving information of time-division duplex (TDD) configuration, and beamforming, etc., from the network device; however, this disclosure is not limited thereto.

About the cell selection procedure.

In some embodiments, the cell selection procedure needs to be performed when the repeater is transferred from registration management-deregistered (RM-DEREGISTERED) to registration management-registered (REGISTERED), or from connection management-idle state (CM-IDEL) to connection management-connected state (CM-CONNECTED) and from connection management-connected state (CM-CONNECTED) to connection management-idle state (CM-IDEL).

In some embodiments, a specific cell selection procedure may include the following.

A non-access stratum (NAS) of the repeater determines a selected public land mobile network (PLMN) and equivalent PLMNs, wherein in a scenario where the repeater is deployed or controlled by an RAN node, the repeater does not need to acquire information on the PLMNs via the NAS.

Furthermore, the cell selection procedure includes an initial cell selection procedure and a cell selection procedure for storing information. The initial cell selection procedure includes scanning all RF channels in a frequency band by the repeater, performing cell search at each frequency by the repeater. The cell selection procedure for storing information includes receiving and storing information of frequencies (and optional cell parameter information) from previous measurement configuration or a previously detected cell by the repeater, and preferentially performing cell search at these frequencies by the repeater. Wherein, for each carrier frequency, in a specific cell search procedure, the repeater determines a cell with a strongest energy value in cell defining-synchronization signal and PBCH blocks (CD-SSBs) according to a synchronization raster, and then reads system information of the cell, so as to determine PLMN(s) of the cell.

Furthermore, the repeater determines a suitable cell, and if it is unable to determine a suitable cell, it attempts to determine an acceptable cell. When it finds a suitable cell or if only one acceptable cell is found, it camps on the cell and begins a cell reselection procedure.

For example, a suitable cell is a cell with measured cell attributes satisfying a cell selection criterion; optionally, the cell PLMN is a selected PLMN, or a registered PLMN, or an equivalent PLMN; the cell is not barred (i.e. allowed) or is not reserved, and the cell does not belong to a tracking area in a “roaming-barred tracking area” list, wherein the cell is not barred or reserved.

For example, an acceptable cell is a cell with measured cell attributes satisfying a cell selection criterion and is not barred.

About the cell reselection procedure.

In some embodiments, when the repeater is in an RRC idle state or an RRC inactive state, a specific cell reselection procedure may include the following:

at a specific carrier frequency, the repeater determines a cell with a strongest energy value in cell defining-synchronization signal and PBCH blocks (CD-SSBs) according to a synchronization raster.

Furthermore, the repeater performs attributes measurement of a serving cell and neighboring cells, so as to ensure the selected cell in the reselection procedure, wherein for search and measurement of inter-frequency neighboring cells, specific carrier frequencies for performing search and measurement only need to be indicated.

Furthermore, a cell where the repeater should camp is determined in the cell reselection based on the following cell reselection criterion that:
intra-frequency reselection is based on cell ranking;
inter-frequency reselection is based on absolute priorities, and the repeater attempts to camp on a highest available priority frequency;
the serving cell may provide a neighbor cell list (NCL), and specific situations of intra-frequency and inter-frequency neighboring cells are dealt;
black lists may be provided to prevent the repeater from reselecting to specific intra-frequency and inter-frequency neighboring cells;
white lists may be provided, requiring the repeater to only reselect to specific intra-frequency and inter-frequency neighboring cells;
cell reselection may be speed related;
service-specific prioritization; and
the cell is a cell that is not barred.

That is, in the cell selection and reselection procedure, the premise that a cell is able to be a candidate cell for cell selection or reselection is, or in other words, a condition that a cell is considered as a candidate cell that needs to be at least satisfied is, that the repeater determines (considers) that an access state of a cell is allowed or not barred or supported or reserved.

It should be noted that the above candidate cell may also be considered as that the cell is accessible, or considered as that the cell is not barred, or considered as that the cell is a suitable cell, or considered as that the cell is an acceptable cell, or considered as that the cell is able to camp normally, or considered as that the cell is able to be selected and/or reselected; correspondingly, being not a candidate cell may also be considered as that the cell is barred, or considered as that the cell is not a suitable cell, or considered as that the cell is not an acceptable cell, or considered as that the cell is not reselected, or considered as that the cell is excluded from candidates of the cell selection and/or reselection, or considered as that the cell is excluded from candidates of the cell selection and/or reselection for a predetermined period of time (e.g. 300 seconds), etc., and these expressions are not limited in the embodiments of this disclosure.

How the repeater determines the access state of the cell shall be described below.

In some embodiments, the relevant information of cell selection or reselection includes cell state information and/or cell restriction information and/or intra-frequency reselection information. The relevant information of cell selection or reselection is carried by a master system information block (MIB) and/or a system information block (SIB), wherein the system information block includes SIB1 and other SIBs, such as SIB2 and SIB3, etc. Reference may be made to existing techniques for specific contents of SIB1 and the other SIBs, which are not limited in this disclosure.

In some embodiments, the relevant information of cell selection or reselection includes existing cell state information and/or cell restriction information and/or intra-frequency reselection information, optionally, it may further include or not include newly-added cell state information and/or cell restriction information and/or intra-frequency reselection information, and the repeater ignores the (existing) relevant information of cell selection or reselection, and/or determines whether the cell can be considered as a candidate cell of the repeater in the cell selection or reselection procedure. Or, the repeater may use the (existing) relevant information of cell selection or reselection to determine whether the cell can be considered as a candidate cell of the repeater in the cell selection or reselection procedure. Or, the repeater may determine whether the cell can be considered as a candidate cell of the repeater in the cell selection or reselection procedure according to (newly-added) repeater-specific relevant information of cell selection or reselection, which shall be described below respectively.

(I) The repeater ignores the (existing) relevant information of cell selection or reselection, and/or determines that the cell is considered by the repeater in the cell selection or reselection procedure as being allowed or not barred or supported or reserved.

The “ignores” above may also be replaced with “does not apply/not applicable”, or “does not use”, or “skips”, etc., and the embodiments of this disclosure is not limited thereto.

In some embodiments, that the repeater ignores the relevant information of cell selection or reselection includes ignoring existing cell state information and/or cell restriction information and/or intra-frequency reselection information, wherein the existing cell state information and/or cell restriction information and/or intra-frequency reselection information indicate(s) cell state information and/or cell restriction information and/or intra-frequency reselection information configured by the network device for the terminal equipment and/or the IAB-MT, i.e. cell state information and/or cell restriction information and/or intra-frequency reselection information applicable to the terminal equipment and/or the IAB-MT.

In some embodiments, the above cell state information includes at least one of the following information:
cell state information applicable to a normal terminal equipment (user equipment), wherein cell state information of the normal terminal equipment being indicated by a specific field (domain) in an MIB message, such as a field “cellBarred” in the MIB message, wherein in a case where the field “cellBarred” is “barred”, it means that the cell is barred or considered by the normal terminal equipment as being barred, and in a case where the field “cellBarred” is “not barred”, it means that the cell is not barred or considered by the normal terminal equipment as being not barred;
cell state information applicable to a reduced capability terminal equipment (RedCap UE), wherein the cell state information of the reduced capability terminal equipment (RedCap UE) may be indicated by specific fields (domains) in the SIB1 message, such as fields “cellBarredRedCap1Rx-r17” and “cellBarredRedCap2Rx” in the SIB1 message; in a case where the field “cellBarredRedCap1Rx-r17” is “barred”, the cell is barred for a RedCap UE with one Rx branch or the cell is considered as being barred by a RedCap UE with one Rx branch, and in a case where the field “cellBarredRedCap2Rx-r17” is “barred”, the cell is barred for a RedCap UE with two Rx branches or the cell is considered as being barred by a RedCap UE with two Rx branches; and
cell state information applicable to an integrated access backhaul (IAB) or an IAB-MT, wherein the cell state information of the IAB or IAB-MT may be indicated by an IAB-related field (domain) in the SIB1 message, such as a field “iab-Support” in the SIB1 message; if the field “iab-Support” is “true”, the cell may be used for (supporting) the IAB and is a cell supported by an IAB node, and if the field is absent, the cell is unable to be used for the IAB, that is, it does not support an IAB node.

In some embodiments, the above cell restriction information includes the following information:
cell restriction information applicable to a terminal equipment (including a normal terminal equipment and a RedCap UE) and/or an IAB-MT, wherein the cell restriction information applicable to a terminal equipment and/or an IAB-MT includes at least one of the following: a cell reserved state for operator use (cellReservedForOperatorUse), a cell reserved state for other use (cellReservedForOtherUse), and a cell reserved state for future use (cellReservedForFutureUse), and the cell restriction information may be carried by an SIB1 message; for example, for cellReservedForOperatorUse, it is not applicable to an IAB-MT with a non-public network (NPN) capability, but is applicable to a terminal equipment (including a normal terminal equipment and/or a Redcap UE) and an IAB-MT with no NPN capability; for cellReservedForOtherUse, when an IAB-MT determines cell barring, it ignores this information; however, when an IAB-MT with an NPN capability determines an NPN-only cell, it takes the information into account; and for cellReservedForFutureUse, it is not applicable to an IAB-MT, but is applicable to a terminal equipment. In a case where a field in the above restriction information field is “not reserved” or “true”, it means that the cell is considered as being non-reserved or supporting the terminal equipment and/or the IAB-MT, and if the field is “reserved” or absent, it means that the cell is considered as being reserved or not supporting the terminal equipment and/or the IAB-MT.

In some embodiments, the above intra-frequency reselection information includes intra-frequency reselection information applicable to a normal terminal equipment and/or intra-frequency reselection information used for a RedCap UE.

For example, the intra-frequency reselection information applicable to a terminal equipment (including a normal terminal equipment and a RedCap UE) is carried by an MIB message, such as a field “intraFreqReselection” in the MIB message; wherein for intra-frequency cells, in a case where a cell ranking highest is barred or considered by the terminal equipment as being barred, such as when a field “cellBarred” in an MIB message in cell 1 is “barred”, and a value of a field “intralfreqReselection” in the MIB message is “allowed”, cell selection or reselection may be continued on an other cell with the same frequency as cell 1, such as cell 2; otherwise, if the value of the field “intralfreqReselection” is “not allowed”, cell selection or reselection may not be performed on an other cell with the same frequency as cell 1, such as cell 2.

For another example, the intra-frequency reselection information applicable to a reduced capacity terminal equipment (RedCap UE) is carried by an SIB1 message, such as a field “intraFreqReselectionRedCap-r17” in the SIB1 message, when a cell ranking highest is barred or considered by the RedCap UE as being barred, selection or reselection by the RedCap UE on other intra-frequency cells is controlled, and its values include “allowed” and “not allowed” (which is similar to the above implementation, and shall not be repeated herein any further). If this field is absent, the RedCap UE will consider that the cell is barred, that is, the cell is considered as not supporting the RedCap.

For example, the repeater ignores the existing cell state information cellBarred and the intra-frequency reselection information intraFreqReselection in the MIB message applicable to a normal terminal equipment, and the following fields are taken as examples:

### MIB

-- ASN1START
-- TAG-MIB-START

| | |
|---|---|
| MIB ::= | SEQUENCE { |
| systemFrameNumber | BIT STRING (SIZE (6)), |
| subCarrierSpacingCommon | ENUMERATED {scs15or60, |

scs30or120},

| | |
|---|---|
| ssb-SubcarrierOffset | INTEGER (0..15), |
| dmrs-TypeA-Position | ENUMERATED {pos2, pos3}, |
| pdcch-ConfigSIB1 | PDCCH-ConfigSIB1, |
| cellBarred | ENUMERATED {barred, |

notBarred},

| | |
|---|---|
| intraFreqReselection | ENUMERATED {allowed, |

notAllowed},

| | |
|---|---|
| spare | BIT STRING (SIZE (1)) |

}
-- TAG-MIB-STOP
-- ASN1STOP

Wherein, the field “cellBarred” may be set to be ignored by the repeater, and/or the field “intraFreqReselection” may be set to be ignored by the repeater, for example,

MIB field descriptions

cellBarred
Value barred means that the cell is barred, as defined in TS 38.304 [20].
This field is ignored by IAB-MT and NCR.
...
intraFreqReselection
Controls cell selection/reselection to intra-frequency cells when the highest
ranked cell is barred, or treated as barred by the UE, as specified in TS
38.304 [20]. This field is ignored by IAB-MT and NCR.
...

As shown above, when the repeater receives the MIB message, it ignores the field “cellBarred” in the MIB message and directly considers the cell as being not barred, and/or, ignore the field “intraFreqReselection” in the MIB message and directly considers the cell or a cell at the same frequency as the cell with ranking high as being barred or as being considered as being barred. The cell at the same frequency as the cell is not barred, or, in other words, it may be considered as a candidate cell in cell reselection.

It should be noted that in the cell reselection procedure, when the cell state is “barred” or the cell state is processed as it is “barred”, in a case where the repeater may acquire a current cell state (not because it is unable to acquire that the cell is processed as the cell state is “barred”), the repeater ignores the field “intraFreqReselection” in the MIB message (regardless of whether the field is set to be allowed), and if a reselection criterion is satisfied, the repeater may select another cell at the same frequency.

And/or, for example, the repeater ignores the cell restriction information in the SIB1 message, and the following fields are taken as examples:

### CellAccessRelatedInfo Field Descriptions

| -- ASN1START | |
|---|---|
| -- TAG-CELLACCESSRELATEDINFO-START | |
| CellAccessRelatedInfo ::= | SEQUENCE { |
| plmn-IdentityInfoList | PLMN-IdentityInfoList, |
| cellReservedForOtherUse | ENUMERATED {true} |
| OPTIONAL, -- Need R | |
| ..., | |
| [[ | |
| cellReservedForFutureUse-r16 | ENUMERATED {true} |
| OPTIONAL, -- Need R | |
| npn-IdentityInfoList-r16 | NPN-IdentityInfoList-r16 |

OPTIONAL -- Need R
]]
}
-- TAG-CELLACCESSRELATEDINFO-STOP

### PLMN-IdentityInfo Field Descriptions

-- TAG-PLMN-IDENTITYINFOLIST-START

| | |
|---|---|
| PLMN-IdentityInfoList ::= | SEQUENCE (SIZE (1..maxPLMN)) |

OF PLMN-IdentityInfo

| | |
|---|---|
| PLMN-IdentityInfo ::= | SEQUENCE { |
| plmn-IdentityList | SEQUENCE (SIZE |

(1..maxPLMN)) OF PLMN-Identity,

| | |
|---|---|
| trackingAreaCode | TrackingAreaCode |

OPTIONAL, -- Need R

| | |
|---|---|
| ranac | RAN-AreaCode |

OPTIONAL, -- Need R

| | |
|---|---|
| cellIdentity | CellIdentity, |
| cellReservedForOperatorUse | ENUMERATED {reserved, |

```
notReserved},
  ...,
    [[
```

| | |
|---|---|
| iab-Support-r16 | ENUMERATED {true} |

OPTIONAL -- Need S
]]
}
-- TAG-PLMN-IDENTITYINFOLIST-STOP

The field “cellReservedForOtherUse” may be set to be ignored by the repeater, and/or the field “cellReservedForFutureUse-r16” may be set to be ignored by the repeater, and/or the field “cellReservedForOperatorUse” may be set to be ignored by the repeater, for example:

CellAccessRelatedInfo field descriptions

cellReservedForFutureUse
Indicates whether the cell is reserved, as defined in 38.304 [20] for future use. The field
is applicable to all PLMNs and NPNs. This field is ignored by IAB-MT and NCR.
cellReservedForOtherUse
Indicates whether the cell is reserved, as defined in 38.304 [20]. The field is applicable
to all PLMNs. This field is ignored by IAB-MT for cell barring determination, but still
considered by NPN capable IAB-MT for determination of an NPN-only cell and NCR

PLMN-IdentityInfo field descriptions

cellReservedForOperatorUse
Indicates whether the cell is reserved for operator use (per PLMN), as
defined in TS 38.304 [20]. This field is ignored by IAB-MT and NCR.

As shown above, when the repeater receives the SIB1 message, it ignores the above field “cellReservedForOtherUse” and directly considers this cell as being reserved; and/or, it ignores the above field “cellReservedForFuture Use-r16”, and directly considers this cell as being reserved; and/or, it ignores the above field “cellReservedForOperatorUse”, and directly considers this cell as being reserved.

It can be seen from the above embodiments that the repeater ignores the relevant information of cell selection or reselection applicable to mobile terminals broadcast by the network device. The repeater may reselect and camp on a cell that is considered as being barred or restricted by the terminal equipment, which ensures flexible deployment of the repeater and lowers costs.

(II) The repeater uses the (existing) relevant information of cell selection or reselection to determine whether the cell is considered by the repeater in the cell selection or reselection procedure as being allowed, or not barred, or being supported, or reserved.

In some embodiments, that the repeater uses the relevant information of cell selection or reselection includes using existing cell state information and/or cell restriction information and/or intra-frequency reselection information, wherein the existing cell state information and/or cell restriction information and/or intra-frequency reselection information indicate(s) cell state information and/or cell restriction information and/or intra-frequency reselection information configured by the network device for the terminal equipment or the IAB-MT, i.e. cell state information and/or cell restriction information and/or intra-frequency reselection information applicable to the terminal equipment or the IAB-MT.

In some embodiments, the repeater uses the cell state information applicable to IAB or IAB-MT to determine whether the cell is considered by the repeater in the cell selection or reselection procedure as being allowed, or being not barred, or being supported, or being reserved.

For example, when a field (such as iab-support) representing cell state information applicable to IAB or IAB-MT is present, the repeater determines that the cell supports the repeater and may be used as a candidate cell of the repeater in the cell selection or reselection procedure, and if the field (such as iab-support) representing cell state information applicable to IAB or IAB-MT is absent, the repeater determines that the cell does not support the repeater and/or may not be used as a candidate cell of the repeater in the cell selection or reselection procedure. Or, when a field (such as iab-support) representing cell state information applicable to IAB or IAB-MT is absent, the repeater determines that the cell supports the repeater and may be used as a candidate cell of the repeater in the cell selection or reselection procedure, and if the field (such as iab-support) representing cell state information applicable to IAB or IAB-MT is present, the repeater determines that the cell does not support the repeater and/or may not be used as a candidate cell of the repeater in the cell selection or reselection procedure.

In some embodiments, the repeater uses the existing cell restriction information of the terminal equipment to determine whether the cell is considered by the repeater in the cell selection or reselection procedure as being allowed, or being not barred, or being supported, or being reserved.

For example, the repeater uses the cell restriction information in the SIB1 message, and the following fields are taken as examples:

### CellAccessRelated Field Descriptions

| -- ASN1START | |
|---|---|
| -- TAG-CELLACCESSRELATEDINFO-START | |
| CellAccessRelatedInfo ::= | SEQUENCE { |
| plmn-IdentityInfoList | PLMN-IdentityInfoList, |
| cellReservedForOtherUse | ENUMERATED {true} |
| OPTIONAL, -- Need R | |
| ..., | |
| [[ | |
| cellReservedForFutureUse-r16 | ENUMERATED {true} |
| OPTIONAL, -- Need R | |
| npn-IdentityInfoList-r16 | NPN-IdentityInfoList-r16 |

OPTIONAL -- Need R
]]
}
-- TAG-CELLACCESSRELATEDINFO-STOP
-- ASN1STOP

### PLMN-IdentityInfo Field Descriptions

-- ASN1START
-- TAG-PLMN-IDENTITYINFOLIST-START

| | |
|---|---|
| PLMN-IdentityInfoList ::= | SEQUENCE (SIZE (1..maxPLMN)) |

OF PLMN-IdentityInfo

| | |
|---|---|
| PLMN-IdentityInfo ::= | SEQUENCE { |
| plmn-IdentityList | SEQUENCE (SIZE |

(1..maxPLMN)) OF PLMN-Identity,

| | |
|---|---|
| trackingAreaCode | TrackingAreaCode |

OPTIONAL, -- Need R

| | |
|---|---|
| ranac | RAN-AreaCode |

OPTIONAL, -- Need R

| | |
|---|---|
| cellIdentity | CellIdentity, |
| cellReservedForOperatorUse | ENUMERATED {reserved, |

```
notReserved} ,
  ...,
    [[
```

| | |
|---|---|
| iab-Support-r16 | ENUMERATED {true} |

OPTIONAL -- Need S
]]
}

### NPN-IdentityInfoList Information Element

-- ASN1START
-- TAG-NPN-IDENTITYINFOLIST-START

| | |
|---|---|
| NPN-IdentityInfoList-r16 ::= | SEQUENCE (SIZE (1..maxNPN-r16)) OF |

NPN-IdentityInfo-r16

| | |
|---|---|
| NPN-IdentityInfo-r16 ::= | SEQUENCE { |
| npn-IdentityList-r16 | SEQUENCE (SIZE (1..maxNPN-r16)) |

OF NPN-Identity-r16,

| | |
|---|---|
| trackingAreaCode-r16 | TrackingAreaCode, |
| ranac-r16 | RAN-AreaCode |

OPTIONAL, -- Need R

| | |
|---|---|
| cellIdentity-r16 | CellIdentity, |
| cellReservedForOperatorUse-r16 | ENUMERATED {reserved, |

notReserved},

| | |
|---|---|
| iab-Support-r16 | ENUMERATED {true} |

OPTIONAL, -- Need S
...
}
-- TAG-NPN-IDENTITYINFOLIST-STOP
-- ASN1STOP

For example, the repeater may use the field “cellReservedForFutureUse”:

CellAccessRelatedInfo field descriptions

cellReservedForFutureUse
Indicates whether the cell is reserved, as defined in 38.304 [20] for future use. The field
is applicable to all PLMNs and NPNs. This field is ignored by IAB-MT. If the field is
present, all UE except NCR shall treat this cell as if cell status is “barred”, while NCR
shall treat this cell as candidate during the cell selection and cell reselection procedures;
if the field is absent, all UE except NCR shall treat this cell as candidate during the cell
selection and cell reselection procedures, while NCR shall treat this cell as if cell status is
“barred”.

As shown above, when the repeater receives the SIB1 message, if the field “cellReservedForFutureUse” is present and is “true”, the repeater considers that the cell is reserved (or, in other words, it may be considered as a candidate cell in the cell selection or reselection procedure), and a normal terminal equipment considers that the cell is barred, and if the field “cellReservedForFutureUse” is absent, the repeater considers that the cell is barred, and the normal terminal equipment considers that the cell is reserved (or, in other words, it may be considered as a candidate cell in the cell selection or reselection procedure).

And/or, for example, the repeater may use the field “cellReservedForOtherUse”:

CellAccessRelatedInfo field descriptions

cellReservedForOtherUse
Indicates whether the cell is reserved, as defined in 38.304 [20]. The field is applicable
to all PLMNs. This field is ignored by IAB-MT for cell barring determination, but still
considered by NPN capable IAB-MT for determination of an NPN-only cell. If the field is
present, all UE except NCR shall treat this cell as if cell status is “barred”, while NCR
shall treat this cell as candidate during the cell selection and cell reselection
procedures; if the field is absent, all UE except NCR shall treat this cell as candidate
during the cell selection and cell reselection procedures, while NCR shall treat this cell
as if cell status is “barred”.

As shown above, when the repeater receives the SIB1 message, if the field “cellReservedForOtherUse” is present and is “true”, the repeater considers that the cell is reserved (or, in other words, it may be considered as a candidate cell in the cell selection or reselection procedure), and the normal terminal equipment considers that the cell is barred, and if the field “cellReservedForOtherUse” is absent, the repeater considers that the cell is barred, and the normal terminal equipment considers that the cell is reserved (or, in other words, it may be considered as a candidate cell in the cell selection or reselection procedure).

And/or, for example, the repeater may use the field “cellReservedForOperatorUse”:

PLMN-IdentityInfo field descriptions
cellReservedForOperatorUse
Indicates whether the cell is reserved for operator use (per PLMN), as defined in TS
38.304 [20]. This field is ignored by IAB-MT. If the field is “not reserved” all UE
except NCR shall treat this cell as if cell status is “barred”, while NCR shall treat this cell
as candidate during the cell selection and cell reselection procedures; if the field is
“reserved”, all UE except NCR shall treat this cell as candidate during the cell selection
and cell reselection procedures, while NCR shall treat this cell as if cell status is
“barred”.
NPN-IdentityInfo field descriptions
cellReservedForOperatorUse
Indicates whether the cell is reserved for operator use (for the NPN(s) identified in
the npn-IdentityList) as defined in TS 38.304 [20]. This field is ignored by NPN
capable IAB-MT. If the field is “not reserved” all UE except NCR shall treat this cell
as if cell status is “barred”, while NCR shall treat this cell as candidate during the cell
selection and cell reselection procedures; if the field is “reserved”, all UE except NCR
shall treat this cell as candidate during the cell selection and cell reselection
procedures, while NCR shall treat this cell as if cell status is “barred”.

As shown above, when the repeater receives the SIB1 message, if the field “cellReservedForOperatorUse” is “reserved”, the repeater considers that the cell is reserved (or, in other words, it may be considered as a candidate cell in the cell selection or reselection procedure), and the normal terminal equipment considers that the cell is barred, and if the field “cellReservedForOperatorUse” is “notReserved”, the repeater considers that the cell is barred, and the normal terminal equipment considers that the cell is reserved (or, in other words, it may be considered as a candidate cell in the cell selection or reselection procedure).

In some embodiments, the repeater may jointly use two or three of the above three fields to jointly determine whether the cell is reserved (or, in other words, it may be considered as a candidate cell in the cell selection or reselection procedure). For example, the field for “cellReservedForFutureUse” is “true” and the field “cellReservedForOperatorUse” is “reserved”; otherwise, the repeater considers that the cell is barred, and the normal terminal equipment considers that the cell is reserved (or, in other words, a candidate cell in the cell selection or reselection procedure), which shall not be enumerated herein any further.

What described above is illustrative only, and the repeater may also use other existing relevant information of cell selection or reselection, which shall not be enumerated herein any further.

It can be seen from the above embodiments that the repeater uses the relevant information of cell selection or reselection applicable to the terminal equipment. The repeater may select or reselect and camp on a cell that is considered as being barred or restricted by the terminal equipment, which ensures flexible deployment of the repeater and lowers costs.

(III) The repeater determines whether a cell is considered by the repeater in the cell selection or reselection procedure as being allowed or being not barred or being supported or being reserved according to the (newly-added) repeater-specific relevant information of cell selection or reselection.

In some embodiments, the “repeater-specific relevant information of cell selection or reselection” may be indicated in an MIB and/or SIB1. The repeater-specific relevant information of cell selection or reselection is a newly-added information element (IE) in the above relevant information, and a state of the cell may be indicated by a field value (type), and/or may be indicated by presence and absence of the information element. For example, the repeater-specific relevant information of cell selection or reselection is used to indicate whether the cell (and/or an intra-frequency cell) may be considered as a candidate cell of the repeater in the cell selection or reselection procedure, and/or is used to indicate whether the cell (and/or an intra-frequency cell) supports the repeater, and/or is used to indicate whether the cell (and/or an intra-frequency cell) is considered by the repeater in the cell selection or reselection procedure as being barred, and/or is considered by the repeater in the cell selection or reselection procedure as being reserved.

It should be noted that following field values (types) may be “barred”/“not barred”, “reserved”/“not reserved”, “true”, “supported”, and “allowed”/“not allowed”, etc. Names of following fields may be replaced with other names, and the embodiments of this disclosure is not limited thereto. The repeater-specific relevant information of cell selection or reselection shall be described below by way of examples.

In some embodiments, the repeater-specific relevant information of cell selection or reselection includes or does not include repeater-specific cell state information and/or cell restriction information. The repeater-specific cell state information and/or cell restriction information is/are used to indicate whether the cell may be considered as a candidate cell of the repeater in the cell selection or reselection procedure, and/or used to indicate whether the cell supports the repeaters, and/or used to indicate whether the cell is considered by the repeater in the cell selection or reselection procedure as being barred, and/or used to indicate whether the cell is considered by the repeater in the cell selection or reselection procedure as being reserved, and so on.

In some embodiments, the repeater-specific cell state information is used to indicate whether the cell is considered by the repeater in the cell selection or reselection procedure as being barred, the specific-cell restriction information is used to indicate whether the cell is considered by the repeater in the cell selection or reselection procedure as being reserved, and the specific-cell state information and cell restriction information are used to indicate whether the cell is considered as a candidate cell of the repeater in the cell selection or reselection procedure, and/or whether the cell supports the repeater.

In some embodiments, the state of the cell may be indicated by field values (types).

For example, the repeater-specific cell state information is introduced into the MIB, and the following fields are taken as examples:

### MIB

| -- TAG-MIB-START | |
|---|---|
| MIB ::= | SEQUENCE { |
| systemFrameNumber | BIT STRING (SIZE (6)), |
| subCarrierSpacingCommon | ENUMERATED {scs15or60, |
| scs30or120}, | |
| ssb-SubcarrierOffset | INTEGER (0..15), |
| dmrs-TypeA-Position | ENUMERATED {pos2, pos3}, |
| pdcch-ConfigSIB1 | PDCCH-ConfigSIB1, |
| cellBarred | ENUMERATED {barred, |
| notBarred}, | |
| intraFreqReselection | ENUMERATED {allowed, |
| notAllowed}, | |
| NCR-cellBarred | ENUMERATED {barred, notBarred} |
| [symbol] | [symbol] |

}
-- TAG-MIB-STOP
-- ASN1STOP

MIB field descriptions

NCR-cellBarred
Value barred means that the cell is barred for NCR This field is
ignored by UE and IAB-MT.

As shown above, a spare field (1 bit) in the MIB message is modified into a field “NCR-cellBarred”, which is used to indicate whether the cell is considered as being barred for the repeater. If the field “NCR-cellBarred” is “barred”, the cell is barred for the repeater, and if the field “NCR-cellBarred” is “not Barred”, this cell is not barred for the repeater. Furthermore, for a normal terminal equipment or an IAB-MT device, this field is ignored.

In some embodiments, the state of the cell may be indicated by presence or absence of the information element.

For example, the repeater-specific cell restriction information is introduced into the MIB, and the following fields are taken as examples:

### MIB

-- ASN1START
-- TAG-MIB-START

| | |
|---|---|
| MIB ::= | SEQUENCE { |
| systemFrameNumber | BIT STRING (SIZE (6)), |
| subCarrierSpacingCommon | ENUMERATED {scs15or60, |

scs30or120},

| | |
|---|---|
| ssb-SubcarrierOffset | INTEGER (0..15), |
| dmrs-TypeA-Position | ENUMERATED {pos2, pos3}, |
| pdcch-ConfigSIB1 | PDCCH-ConfigSIB1, |
| cellBarred | ENUMERATED {barred, |

notBarred},

| | |
|---|---|
| intraFreqReselection | ENUMERATED {allowed, |

notAllowed},

| | |
|---|---|
| cellForNCR | ENUMERATED {true} |

OPTINAL, -- Need s

| | |
|---|---|
| [symbol] | [symbol] |

}
-- TAG-MIB-STOP
-- ASN1STOP

MIB field descriptions

cellForNCR
Indicates whether NCR is supported by the cell. If the field is
present, the cell supports NCR; if the field is absent, the cell
does not support NCR. This field is ignored by UE and IAB-MT.

As shown above, a spare field (1 bit) in the MIB message is modified into a field “cellForNCR”, which is used to indicate whether the cell supports the repeater. If the field “cellForNCR” is “true”, the cell supports an NCR, or, in other words, the cell is a supporting cell, and in a case where the field “cellForNCR” is absent, this cell does not support an NCR for the repeater, and vice versa. Furthermore, for a normal terminal equipment or an IAB-MT device, this field is ignored.

Or, for example, the repeater-specific cell state information and cell restriction information are introduced into the MIB, and the following fields are taken as examples:

### MIB

- ASN1START
-- TAG-MIB-START

| | |
|---|---|
| MIB ::= | SEQUENCE { |
| systemFrameNumber | BIT STRING (SIZE (6)), |
| subCarrierSpacingCommon | ENUMERATED {scs15or60, |

scs30or120},

| | |
|---|---|
| ssb-SubcarrierOffset | INTEGER (0..15), |
| dmrs-TypeA-Position | ENUMERATED {pos2, pos3}, |
| pdcch-ConfigSIB1 | PDCCH-ConfigSIB1, |
| cellBarred | ENUMERATED {barred, |

notBarred},

| | |
|---|---|
| intraFreqReselection | ENUMERATED {allowed, |

notAllowed},

| | |
|---|---|
| NCR-Support | ENUMERATED {true} |

OPTINAL, -- Need s

| | |
|---|---|
| [symbol] | [symbol] |

}
-- TAG-MIB-STOP
-- ASN1STOP

MIB field descriptions

NCR-Support
This field combines both the support of NCR and the cell status for
NCR If the field is present, the cell supports NCR
and the cell is also considered as a candidate for cell
(re)selection for NCRs; if the field is absent, the cell does
not support NCR and/or the cell is barred for NCR.
This field is ignored by UE and IAB-MT.

As shown above, a spare field (1 bit) in the MIB message is modified into a field “NCR-Support”, which is used to indicate whether the cell supports the repeater and/or used to indicate whether the cell is barred for the repeater. If the field “NCR-Support” is “true”, the cell supports an NCR and the cell is reserved or not barred, and in a case where the field “NCR-Support” is absent, this cell does not support an NCR or the cell is barred for the repeater, and vice versa. Furthermore, for a normal terminal equipment or an IAB-MT device, this field is ignored.

In some embodiments, the repeater-specific relevant information of cell selection or reselection includes repeater-specific intra-frequency reselection information. The repeater-specific intra-frequency reselection information is used to indicate whether a cell at the same frequency as the cell considered as being barred (ranking highest) may be considered as a candidate cell of the repeater in the cell selection or reselection procedure, or, in other words, used to indicate whether the repeater may perform cell selection or reselection on a cell at the same frequency as the cell considered as being barred (ranking highest).

For example, the repeater-specific intra-frequency reselection information is introduced into the MIB, and the following fields are taken as examples:

### MIB

-- ASN1START
-- TAG-MIB-START

| | |
|---|---|
| MIB ::= | SEQUENCE { |
| systemFrameNumber | BIT STRING (SIZE (6)), |
| subCarrierSpacingCommon | ENUMERATED {scs15or60, |

scs30or120},

| | |
|---|---|
| ssb-SubcarrierOffset | INTEGER (0..15), |
| dmrs-TypeA-Position | ENUMERATED {pos2, pos3}, |
| pdcch-ConfigSIB1 | PDCCH-ConfigSIB1, |
| cellBarred | ENUMERATED {barred, |

notBarred},

| | |
|---|---|
| intraFreqReselection | ENUMERATED {allowed, |

notAllowed},

| | |
|---|---|
| NCR-intraFreqReselection | ENUMERATED {allowed, |

notAllowed}OPTINAL, -- Need s

| | |
|---|---|
| [symbol] | [symbol] |

}
-- TAG-MIB-STOP
-- ASN1STOP

MIB field descriptions

NCR-intraFreqReselection
Controls cell selection/reselection to intra-frequency cells when the
highest ranked cell is barred, or treated as barred by the NCR. This
field is ignored by UE and IAB-MT.

As shown above, a spare field (1 bit) in the MIB message is modified into a field “NCR-intraFreqReselection”, which is used to indicate whether a cell at the same frequency as the barred cell may be considered as a candidate cell of the repeater in the cell selection or reselection procedure, wherein for cells at the same frequency, when a cell ranking highest, such as a field “cellBarred” in the MIB message in cell 1, is “barred”, and a value of a field “NCR-intraFreqReselection” in the MIB message is “allowed”, for the repeater, it considers that cell 1 is barred, and for another cell at the same frequency as cell 1, such as cell 2, the repeater considers that cell 2 is a candidate cell in the cell selection or reselection procedure. For example, cell selection/reselection may be continued on cell 2; otherwise, if the value of the field “NCR-intraFreqReselection” is “not allowed”, for another cell at the same frequency as cell 1, such as cell 2, the repeater considers that cell 2 may not be considered as a candidate cell in the cell selection or reselection procedure, that is, the repeater does not continue to perform cell selection or reselection on cell 2. Furthermore, for a normal terminal equipment or an IAB-MT device, this field is ignored.

It should be noted that in the cell reselection procedure, when the cell state is “barred” or the cell state is processed as it is “barred”, in a case where the repeater may acquire a current cell state (not because it is unable to acquire that the cell is processed as the cell state is “barred”),
if a field “NCR-intraFreqReselection” in the MIB message or the SIB1 message is set to be “allowed”, another cell at the same frequency may be considered as a candidate cell, and the NCR may select the another cell at the same frequency when a reselection criterion is satisfied;
if the field “NCR-intraFreqReselection” in the MIB message is set to be “allowed” but the repeater considers that the current cell state is “barred” due to that it is unable to acquire the SIB1 message, the repeater may exclude this cell from being considered as a candidate cell for cell selection or reselection for up to 300 seconds; otherwise, for example, if the field “NCR-intraFreqReselection” in the MIB message is set to be “allowed” but the repeater considers that the current cell state is “barred” not due to that it is unable to acquire the SIB1 message, the repeater shall exclude this cell from being considered as a candidate cell for cell selection or reselection for 300 seconds;
if the field “NOR-intraFreqReselection” in the MIB message is set to be “not allowed” and the repeater considers that the current cell state is “barred” due to that it is unable to acquire the SIB1 message, the repeater may exclude this cell from being considered as a candidate cell for cell selection or reselection for up to 300 seconds; otherwise, for example, if the field “NOR-intraFreqReselection” in the MIB message is set to be “not allowed” and the repeater considers that the current cell state is “barred” not due to that it is unable to acquire the SIB1 message, the repeater shall exclude this cell from being considered as a candidate cell for cell selection or reselection for 300 seconds; alternatively, the repeater shall not reselect another cell at the same frequency as the barred cell, and exclude cells at the same frequency from being considered as candidate cells for cell selection or reselection for 300 seconds; or, the NCR may select the other cell at the same frequency when a reselection criterion is satisfied.

For example, the repeater-specific cell state information and/or cell restriction information may be introduced into the SIB1 message.

A mode for introducing the repeater-specific cell state information or cell restriction information into the SIB1 message is similar to the mode for introducing the repeater-specific cell state information or cell restriction information into the MIB message described above. For example, cellReservedForNCR, cellForNCR, and NCR-Support, etc., are introduced into cellAccessRelatedInfo shown above, and values of these fields or whether these fields are present indicate(s) whether the cell is considered by the repeater in the cell selection or reselection procedure as being reserved, or indicate(s) whether the NCR is supported or not, which shall not be enumerated herein any further.

In some embodiments, in a case where the system information block (SIB1) indicates multiple PLMNs or SNPNs, the repeater-specific cell state information and/or cell restriction information is/are specific per PLMN or per NPN, or, the repeater-specific cell state information and/or cell restriction information is/are common to the multiple PLMNs or NPNs.

For example, in a case where the field “NCR-Support” is used to indicate “the repeater-specific cell state information and/or cell restriction information”, the repeater-specific cell state information and/or cell restriction information is/are specific per PLMN or per NPN, or common to the multiple PLMNs or NPNs.

For example, the repeater-specific cell state information and cell restriction information are introduced into SIB1 message, and the following fields related to the PLMNs or NPNs are taken as examples:

### PLMN-IdentityInfo Field Descriptions

| -- TAG-PLMN-IDENTITYINFOLIST-START | |
|---|---|
| PLMN-IdentityInfoList ::= | SEQUENCE (SIZE (1..maxPLMN)) |
| OF PLMN-IdentityInfo | |
| PLMN-IdentityInfo ::= | SEQUENCE { |
| plmn-IdentityList | SEQUENCE (SIZE |
| (1..maxPLMN)) OF PLMN-Identity, | |
| trackingAreaCode | TrackingAreaCode |
| OPTIONAL, -- Need R | |
| ranac | RAN-AreaCode |
| OPTIONAL, -- Need R | |
| cellIdentity | CellIdentity, |
| cellReservedForOperatorUse | ENUMERATED {reserved, |
| notReserved}, | |
| ..., | |
| [[ | |
| iab-Support-r16 | ENUMERATED {true} |
| OPTIONAL -- Need S | |
| ]] | |
| [[ | |
| NCR-Support | ENUMERATED {true} |

OPTIONAL -- Need S
]]}
-- TAG-PLMN-IDENTITYINFOLIST-STOP

### NPN-IdentityInfoList Field Descriptions

- ASN1START
-- TAG-NPN-IDENTITYINFOLIST- START

| | |
|---|---|
| NPN-IdentityInfoList-r16 ::= | SEQUENCE (SIZE (1..maxNPN-r16)) OF |

NPN-IdentityInfo-r16

| | |
|---|---|
| NPN-IdentityInfo-r16 ::= | SEQUENCE { |
| npn-IdentityList-r16 | SEQUENCE (SIZE (1..maxNPN-r16)) |

OF NPN-Identity-r16,

| | |
|---|---|
| trackingAreaCode-r16 | TrackingAreaCode, |
| ranac-r16 | RAN-AreaCode |

OPTIONAL, -- Need R

| | |
|---|---|
| cellIdentity-r16 | CellIdentity, |
| cellReservedForOperatorUse-r16 | ENUMERATED {reserved, |

notReserved},

| | |
|---|---|
| iab-Support-r16 | ENUMERATED {true} |

OPTIONAL, -- Need S

| | |
|---|---|
| NCR-Support | ENUMERATED {true} |

OPTIONAL -- Need S
...
}
-- TAG-NPN-IDENTITYINFOLIST-STOP
-- ASN1STOP

PLMN-IdentityInfo field descriptions
NCR-Support
This field combines both the support of NCR and the cell status
for NCR. If the field is present, the cell supports NCR and
the cell is also considered as a candidate for cell
(re)selection for NCRs; if the field is absent, the
cell does not support NCR and/or the
cell is barred for NCR. This field is ignored by UE and IAB-MT.
NPN-IdentityInfo field descriptions
NCR-Support
This field combines both the support of NCR and the cell status
for NCR. If the field is present, the cell supports
NCR and the cell is also considered as a candidate for cell
(re)selection for NCRs; if the field is absent, the cell does
not support NCR and/or the cell is barred for NCR.
This field is ignored by UE and IAB-MT.

For example, the field “NOR-Support” is added to a field PLMN-IdentityInfo and/or a field NPN-IdentityInfoList in the SIB1 message, and is used to indicate whether the cell supports the repeater and/or whether the cell is barred for the repeater. If the field “NOR-Support” is present and is “true”, the cell supports an NCR and the cell is not barred for the repeater, and in a case where the field “NOR-Support” is absent, this cell does not support an NCR or the cell is barred for the repeater, and vice versa. Furthermore, for a normal terminal equipment or an IAB-MT device, this field is ignored.

In some embodiments, when all relevant information matched with a first PLMN and/or a first NPN does not include the above repeater-specific cell state information and/or cell restriction information (such as not including the above field “NOR-Support”), it is determined that the cell does not support an NCR (is barred), and/or the cell may not be considered as a candidate cell of the repeater in the cell selection or reselection procedure; and when at least one of relevant information matched with the first PLMN and/or the first NPN includes the repeater-specific cell state information and/or cell restriction information (including the above field “NOR-Support”), it is determined that the cell supports an NCR, and/or the cell may be considered as a candidate cell of the repeater in the cell selection or reselection procedure, wherein the first PLMN includes at least one of a selected PLMN, a registered PLMN, and a PLMN in an equivalent PLMN list, and the first NPN includes at least one of a selected SNPN, a registered SNPN, and an SNPS in an equivalent SNPN list.

Or, when all relevant information matched with the first PLMN and/or the first NPN does not include the repeater-specific cell state information and/or cell restriction information, it is determined that the cell supports an NCR, and/or the cell may be considered as a candidate cell of the repeater in the cell selection or reselection procedure; and when at least one of relevant information matched with the following PLMN and/or the first NPN includes the repeater-specific cell state information and/or cell restriction information, it is determined that the cell does not support an NCR (is barred), and/or the cell may not be considered as a candidate cell of the repeater in the cell selection or reselection procedure.

For example, the relevant information matched with the first PLMN refers to a field (such as a PLMN Identity Information field, which is hereinafter referred to as a matching field) having a PLMN-Identity identical to that of the selected PLMN (or the registered PLMN or the PLMN in the equivalent PLMN list) and containing the PLMN-Identity. Likewise, the relevant information matched with the first NPN refers to a field (such as a field NPN-IdentityInfo) having an NPN-Identity identical to that of the selected SNPN (or the registered SNPN or the SNPN in the equivalent SNPN list) and containing the NPN-Identity.

For example, that all relevant information matched with the first PLMN and/or the first NPN does not include the above repeater-specific cell state information and/or cell restriction information indicates that all matching fields do not contain the repeater-specific cell state information and/or cell restriction information (such as “NCR-Support”), and that at least one of relevant information matched with the following the first PLMN and/or the first NPN includes the repeater-specific cell state information and/or cell restriction information indicates that at least one matching field contains the repeater-specific cell state information and/or cell restriction information (such as “NCR-Support”).

It can be seen from the above embodiments that the network device broadcasts the repeater-specific relevant information of cell selection or reselection, and the repeater may select or reselect and camp on a cell that is considered by the terminal equipment as being barred or restricted in use, which ensures flexible deployment of the repeater and lowers costs.

How the repeater determines according to the relevant information of cell selection or reselection whether the state of the cell is allowed or not barred or reserved or supported is described above. When the state of the cell is allowed or not barred or reserved or supported, the cell satisfies one of conditions for being considered as a candidate cell. In addition, quality of the cell needs to be determined and whether quality of the cell satisfies a predetermined condition (such as the S standard). Only when the predetermined condition is satisfied can the cell be selected or reselected as a candidate cell. Reference may be made to existing techniques for details, which shall not be repeated herein any further.

That the information of cell selection or reselection includes cell state information and/or cell restriction information and/or intra-frequency reselection information is illustrated above. However, the embodiments of this disclosure is not limited thereto, and the information of cell selection or reselection may further include minimum received power, a minimum quality level, an offset, and maximum transmit power (configured for the terminal equipment and/or configured for the repeater and is repeater-specific), etc., and reference may be made to existing techniques for details, which shall not be enumerated herein any further.

It can be seen from the above embodiments that in this disclosure, the repeater may determine candidate cells in the cell selection or reselection procedure according to the relevant information of cell selection or reselection, thereby ensuring flexible deployment of smart repeaters and lowering deployment costs.

### Embodiments of a Second Aspect

The embodiments of this disclosure provides a cell state determining method, which shall be described from a side of a network device, with parts identical to those in the embodiments of the first aspect being not going to be repeated herein any further.

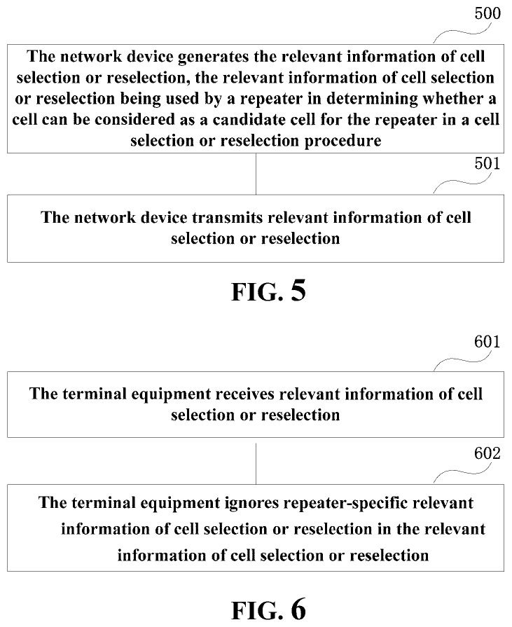

FIG. 5 is a schematic diagram of the cell state determining method of the embodiment of this disclosure. As shown in FIG. 5, the method includes:

501: the network device transmits relevant information of cell selection or reselection, the relevant information of cell selection or reselection being used by a repeater in determining whether a cell can be considered as a candidate cell for the repeater in a cell selection or reselection procedure.

In some embodiments, the network device transmits the relevant information of cell selection or reselection via a master system information block (MIB) and/or a system information block (SIB), wherein the system information block includes SIB1 and other SIBs, such as SIB2 and SIB3, etc. Reference may be made to existing techniques for specific contents of SIB1 and the other SIBs, which are not limited in this disclosure. Reference may be made to the embodiments of the first aspect for implementation of the relevant information of cell selection or reselection, with repeated parts being not going to be described herein any further.

In some embodiments, the method may further include (optional):

500: the network device generates the relevant information of cell selection or reselection.

In some embodiments, the relevant information of cell selection or reselection includes cell state information and/or cell restriction information and/or intra-frequency reselection information.

In some embodiments, the cell state information includes at least one of the following information:
cell state information applicable to a normal terminal equipment (user equipment);
cell state information applicable to a reduced capability terminal equipment (RedCap UE); and
cell state information applicable to an IAB or an IAB-MT.

In some embodiments, the cell restriction information includes the following information:
cell restriction information applicable to a terminal equipment and/or an IAB-MT;
and the intra-frequency reselection information includes intra-frequency reselection information applicable to a normal terminal equipment and/or intra-frequency reselection information applicable to a RedCap UE.

The cell restriction information applicable to the terminal equipment and/or the IAB-MT includes at least one of the following information: a cell reserved state for operator use (cellReservedForOperatorUse), a cell reserved state for other use (cellReservedForOtherUse), and a cell reserved state for future use (cellReservedForFutureUse).

In some embodiments, the relevant information of cell selection or reselection includes or does not include repeater-specific cell state information and/or cell restriction information.

In some embodiments, the repeater-specific cell state information and/or cell restriction information is/are used to indicate whether the cell is considered as a candidate cell of the repeater in the cell selection or reselection procedure; and/or,
indicate whether the cell supports the repeater; and/or,
indicate whether the cell is considered by the repeater in the cell selection or reselection procedure as being barred; and/or,
indicate whether the cell is considered by the repeater in the cell selection or reselection procedure as being reserved.

The relevant information of cell selection or reselection includes repeater-specific intra-frequency reselection information.

In some embodiments, the repeater-specific intra-frequency reselection information is used to indicate whether a cell at the same frequency as the barred cell is can be considered as a candidate cell of the repeater in the cell selection or reselection procedure, or used to indicate whether the repeater is able to perform cell selection or reselection on a cell at the same frequency as the cell considered as being barred.

It should be noted that FIG. 5 only schematically illustrates the embodiments of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 5.

It can be seen from the above embodiments that the repeater may determine candidate cells in the cell selection or reselection procedure according to the relevant information of cell selection or reselection transmitted by the network device, thereby ensuring flexible deployment of smart repeaters and lowering deployment costs.

### Embodiments of a Third Aspect

The embodiments of this disclosure provides a cell state determining method, which shall be described from a side of a terminal equipment.

FIG. 6 is a schematic diagram of the cell state determining method of the embodiment of this disclosure. As shown in FIG. 6, the method includes:

601: the terminal equipment receives relevant information of cell selection or reselection; and

602: the terminal equipment ignores repeater-specific relevant information of cell selection or reselection in the relevant information of cell selection or reselection.

In addition, reference may be made to the embodiments of the first aspect for specific contents of the relevant information of cell selection or reselection, and reference may also be made to the embodiments of the first aspect for a specific cell selection procedure or reselection procedure, with repeated parts being not going to be described herein any further.

In some implementations, the repeater-specific relevant information of cell selection or reselection includes repeater-specific cell state information and/or repeater-specific cell restriction information and/or repeater-specific intra-frequency reselection information.

In addition, reference may be made to the embodiments of the first aspect for specific contents of the repeater-specific cell state information and/or repeater-specific cell restriction information and/or repeater-specific intra-frequency reselection information, with repeated parts being not going to be described herein any further.

It is worth noting that the above FIG. 6 only provides a schematic explanation of the embodiments of this disclosure, but this disclosure is not limited to this. For example, the execution order between various operations may be adjusted appropriately, and in addition, other operations may be added or some of them may be reduced. Technicians in this field may make appropriate modifications based on the above content, not limited to the description in FIG. 6 above.

It can be seen from the above embodiments that the repeater ignores the repeater-specific relevant information of cell selection or reselection in the relevant information of cell selection or reselection, and the terminal equipment will not confuse the repeater-specific relevant information of cell selection or reselection, thereby ensuring that the repeater may determine candidate cells in the cell selection or reselection procedure, and ensuring flexible deployment of smart repeaters and lowering deployment costs.

### Embodiments of a Fourth Aspect

The embodiments of this disclosure provides a cell state determining apparatus. The apparatus may be, for example, a repeater, or may also be one or more components or assemblies configured in the repeater, with contents identical to those in the embodiments of the first aspect being not going to be described herein any further.

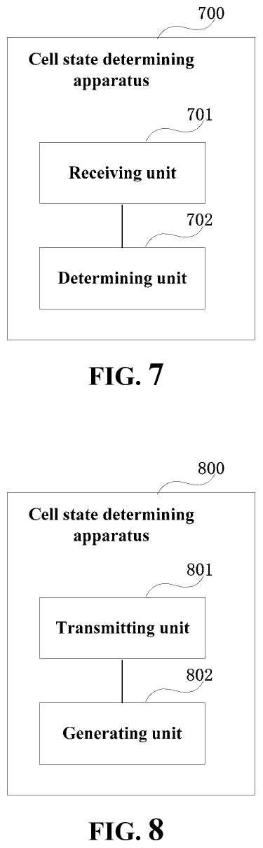

FIG. 7 is a schematic diagram of the cell state determining apparatus of the embodiment of this disclosure. As shown in FIG. 7, the cell state determining apparatus 700 includes:
a receiving unit 701 configured to receive relevant information of cell selection or reselection; and
a determining unit 702 configured to determine whether a cell is can be considered as a candidate cell of the repeater in a cell selection or reselection procedure according to the relevant information of cell selection or reselection.

Hence, the cell state determining apparatus 700 may determine candidate cell in the cell selection or reselection procedure, thereby ensuring flexible deployment of smart repeaters and lowering deployment costs.

It should be noted that FIG. 7 only schematically illustrates the embodiments of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 7.

In some embodiments, the relevant information of cell selection or reselection may be the relevant information of cell selection or reselection described in the embodiments of the first aspect, and reference may be made to the embodiments of the first aspect for specific operations of 701-702, with repeated parts being not going to be described herein any further.

In some embodiments, the determining unit 702 may include (not shown in FIG. 7): a first determining module configured to ignore the relevant information of cell selection or reselection, and/or determine that the cell is can be considered as a candidate cell of the repeater in the cell selection or reselection procedure.

In some embodiments, reference may be made to the embodiments of the first aspect for specific operations of the first determining module in ignoring the relevant information of cell selection or reselection and/or determining that the cell can be considered as a candidate cell of the repeater in the cell selection or reselection procedure, which shall not be repeated herein any further.

In some embodiments, the determining unit 702 may include (not shown in FIG. 7): a second determination module configured to use the relevant information of cell selection or reselection to determine whether the cell can be considered as a candidate cell of the repeater in the cell selection or reselection procedure.

In some embodiments, reference may be made to the embodiments of the first aspect for specific operations of the second determination module in using the relevant information of cell selection or reselection to determine whether the cell can be considered as a candidate cell of the repeater in the cell selection or reselection procedure, which shall not be repeated herein any further.

In some embodiments, the determining unit 702 may include (not shown in FIG. 7): a third determining module configured to determine that the cell is not a candidate cell of the repeater in the cell selection or reselection procedure when the relevant information of cell selection or reselection does not include the repeater-specific cell state information and/or cell restriction information,
and determine that the cell can be considered as a candidate cell of the repeater in the cell selection or reselection procedure when the relevant information of cell selection or reselection includes the repeater-specific cell state information and/or cell restriction information;

or,
a fourth determining module configured to determine that the cell is not a candidate cell of the repeater in the cell selection or reselection procedure when the relevant information of cell selection or reselection includes the repeater-specific cell state information and/or cell restriction information,
and determine that the cell can be considered as a candidate cell of the repeater in the cell selection or reselection procedure when the relevant information of cell selection or reselection does not include the repeater-specific cell state information and/or cell restriction information.

In some embodiments, reference may be made to the embodiments of the first aspect for specific operations of the third determining module or the fourth determining module in determining whether the cell can be considered as a candidate cell of the repeater in the cell selection or reselection procedure, which shall not be repeated herein any further.

In some embodiments, the determining unit 702 may further include (not shown in FIG. 7): a fifth determining module configured to determine that a cell at the same frequency as a barred cell can be considered as a candidate cell of the repeater in the cell selection or reselection procedure in a case where the repeater-specific intra-frequency reselection information is being allowed.

In some embodiments, reference may be made to the embodiments of the first aspect for specific operations of the fifth determining module in determining whether the cell can be considered as a candidate cell of the repeater in the cell selection or reselection procedure, which shall not be repeated herein any further.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and cell state determining apparatus 700 may further include other components or modules, and reference may be made to related techniques for particulars of these components or modules.

Furthermore, for the sake of simplicity, connection relationships between the components or modules or signal profiles thereof are only illustrated in FIG. 7. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

It can be seen from the above embodiments that the repeater may determine candidate cells in the cell selection or reselection procedure according to the relevant information of cell selection or reselection transmitted by the network device, thereby ensuring flexible deployment of smart repeaters and lowering deployment costs.

### Embodiments of a Fifth Aspect

The embodiments of this disclosure provides a cell state determining apparatus. The apparatus may be, for example, a network device, or may also be one or more components or assemblies configured in the network device, with contents identical to those in the embodiments of the second aspect being not going to be described herein any further.

FIG. 8 is a schematic diagram of the cell state determining apparatus of the embodiment of this disclosure. As shown in FIG. 8, the cell state determining apparatus 800 includes:
a transmitting unit 801 configured to transmit relevant information of cell selection or reselection, the relevant information of cell selection or reselection being used by a repeater for determining whether a cell can be considered as a candidate cell of the repeater in a cell selection or reselection procedure.

Hence, the repeater may determine the candidate cell in the cell selection or reselection procedure according to the relevant information of cell selection or reselection transmitted by the cell state determining apparatus 800, thereby ensuring flexible deployment of smart repeaters and lowering deployment costs.

In some embodiments, the transmitting unit 801 carries the relevant information of cell selection or reselection via system information, and reference may be made to the embodiments of the first aspect for implementation of the relevant information of cell selection or reselection, which shall not be repeated herein any further.

In some embodiments, the apparatus may further include (optional):
a generating unit 802 configured to generate the relevant information of cell selection or reselection.

In some embodiments, reference may be made to 501-502 in the embodiments of the second aspect for the transmitting unit 801 and the generating unit 802, and reference may be made to the embodiments of the first aspect for the relevant information of cell selection or reselection, which shall not be repeated herein any further.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the cell state determining apparatus 800 may further include other components or modules, and reference may be made to related techniques for particulars of these components or modules.

Furthermore, for the sake of simplicity, connection relationships between the components or modules or signal profiles thereof are only illustrated in FIG. 8. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

It can be seen from the above embodiments that the repeater may determine candidate cells in the cell selection or reselection procedure according to the relevant information of cell selection or reselection transmitted by the network device, thereby ensuring flexible deployment of smart repeaters and lowering deployment costs.

### Embodiments of a Sixth Aspect

The embodiments of this disclosure provides a cell state determining apparatus. The apparatus may be, for example, a terminal equipment, or may also be one or more components or assemblies configured in the terminal equipment, with contents identical to those in the embodiments of the second aspect being not going to be described herein any further.

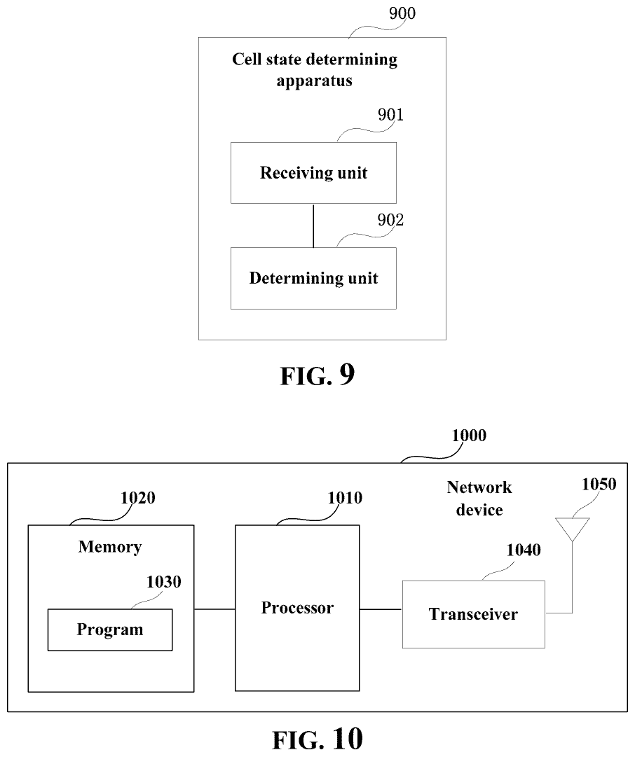

FIG. 9 is a schematic diagram of the cell state determining apparatus of the embodiment of this disclosure. As shown in FIG. 9, the cell state determining apparatus 900 includes:
a receiving unit 901 configured to receive relevant information of cell selection or reselection; and
a determining unit 902 configured to ignore repeater-specific relevant information of cell selection or reselection in the relevant information of cell selection or reselection.

In some embodiments, reference may be made to 601-602 in the embodiments of the third aspect for the receiving unit 901 and the determining unit 902, and reference may be made to the embodiments of the first aspect for the relevant information of cell selection or reselection, which shall not be repeated herein any further.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the cell state determining apparatus 900 may further include other components or modules, and reference may be made to related techniques for particulars of these components or modules.

Furthermore, for the sake of simplicity, connection relationships between the components or modules or signal profiles thereof are only illustrated in FIG. 9. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

It can be seen from the above embodiments that the repeater ignores the repeater-specific relevant information of cell selection or reselection in the relevant information of cell selection or reselection, and the terminal equipment will not confuse the repeater-specific relevant information of cell selection or reselection, thereby ensuring that the repeater may determine candidate cells in the cell selection or reselection procedure, and ensuring flexible deployment of smart repeaters and lowering deployment costs.

### Embodiments of a Seventh Aspect

The embodiments of this disclosure provides a communication system, and reference may be made to FIG. 1, with contents identical to those in the embodiments of the first to the fourth aspects being not going to be described herein any further.

In some embodiments, the communication system may include a network device 1000, a repeater 1100 and a terminal equipment 1200.

In some embodiments, the network device 1000 transmits relevant information of cell selection or reselection, and the repeater 1100 receives the relevant information of cell selection or reselection, and determines whether a cell can be considered as a candidate cell of the repeater in a cell selection or reselection procedure. The relevant information of cell selection or reselection includes cell state information and/or cell restriction information and/or intra-frequency reselection information.

In some embodiments, the network device 1000 transmits relevant information of cell selection or reselection, and the terminal equipment 1200 receives the relevant information of cell selection or reselection, and ignores repeater-specific relevant information of cell selection or reselection in the relevant information of cell selection or reselection.

The embodiments of this disclosure further provides a network device, which may be, for example, a base station. However, this disclosure is not limited thereto, and it may also be another network device.

FIG. 10 is a schematic diagram of a structure of the network device 1000 of the embodiment of this disclosure. As shown in FIG. 10, the network device 1000 may include a processor 1010 (such as a central processing unit (CPU)) and a memory 1020, the memory 1020 being coupled to the processor 1010. Wherein, the memory 1020 may store various data, and furthermore, it may store a program 1030 for information processing, and execute the program 1030 under control of the processor 1010.

For example, the processor 1010 may be configured to execute a program to carry out the cell state determining method as described in the embodiments of the second aspect.

Furthermore, as shown in FIG. 10, the network device 1000 may include a transceiver 1040, and an antenna 1050, etc. Wherein, functions of the above components are similar to those in the related art, and shall not be described herein any further. It should be noted that the network device 1000 does not necessarily include all the parts shown in FIG. 10, and furthermore, the network device 1000 may include parts not shown in FIG. 10, and the related art may be referred to.

The embodiments of this disclosure further provides a repeater; however, this disclosure is not limited thereto, and it may also be other devices, such as a terminal equipment having functions of a repeater.

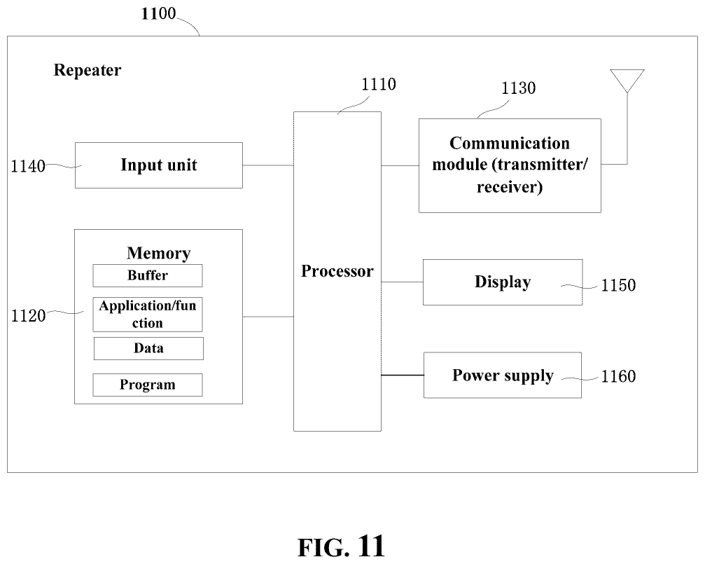

FIG. 11 is a schematic diagram of the repeater 1100 of the embodiment of this disclosure. As shown in FIG. 11, the repeater 1100 may include a processor 1110 and a memory 1120, the memory 1120 storing data and a program and being coupled to the processor 1110. It should be noted that this figure is illustrative only, and other types of structures may also be used, so as to supplement or replace this structure and achieve a telecommunications function or other functions.

For example, the processor 1110 may be configured to execute a program to carry out the cell state determining method as described in the embodiments of the first aspect.

As shown in FIG. 11, the repeater 1100 may further include a communication module 1130, an input unit 1140, a display 1150, and a power supply 1160; wherein functions of the above components are similar to those in the related art, which shall not be described herein any further. It should be noted that the repeater 1100 does not necessarily include all the parts shown in FIG. 11, and the above components are not necessary. Furthermore, the repeater 1100 may include parts not shown in FIG. 11, and the related art may be referred to.

The embodiments of this disclosure further provides a terminal equipment; however, this disclosure is not limited thereto, and it may also be other equipment.

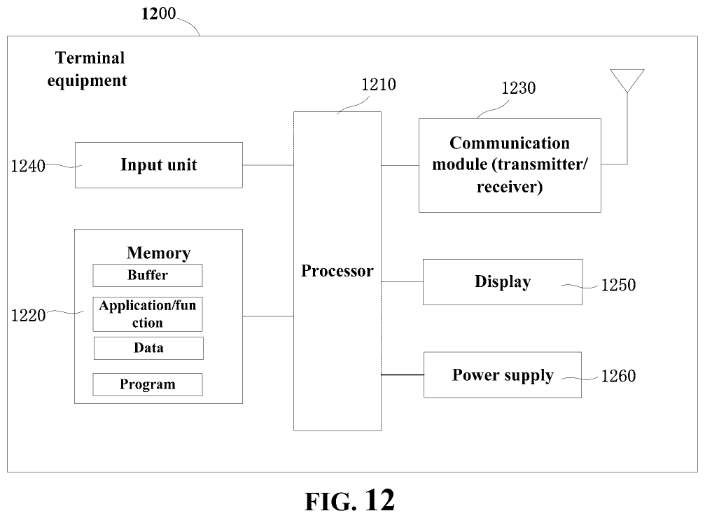

FIG. 12 is a schematic diagram of the terminal equipment of the embodiment of this disclosure. As shown in FIG. 12, the terminal equipment 1200 may include a processor 1210 and a memory 1220, the memory 1220 storing data and a program and being coupled to the processor 1210. It should be noted that this figure is illustrative only, and other types of structures may also be used, so as to supplement or replace this structure and achieve a telecommunications function or other functions.

For example, the processor 1210 may be configured to execute a program to carry out the cell state determining method as described in the embodiments of the third aspect.

As shown in FIG. 12, the terminal equipment 1200 may further include a communication module 1230, an input unit 1240, a display 1250, and a power supply 1260; wherein functions of the above components are similar to those in the relatedart, which shall not be described herein any further. It should be noted that the terminal equipment 1200 does not necessarily include all the parts shown in FIG. 12, and the above components are not necessary. Furthermore, the terminal equipment 1200 may include parts not shown in FIG. 12, and the related art may be referred to.

An embodiment of this disclosure provides a computer readable program code, which, when executed in a repeater, will cause the repeater to carry out the cell state determining method as described in the embodiments of the first aspect.

An embodiment of this disclosure provides a computer readable medium, including a computer readable program code, which will cause a repeater to carry out the cell state determining method as described in the embodiments of the first aspect.

An embodiment of this disclosure provides a computer readable program, which, when executed in a network device, will cause the network device to carry out the cell state determining method as described in the embodiments of the second aspect.

An embodiment of this disclosure provides a computer readable medium, including a computer readable program code, which will cause a network device to carry out the cell state determining method as described in the embodiments of the second aspect.

An embodiment of this disclosure provides a computer readable program, which, when executed in a terminal equipment, will cause the terminal equipment to carry out the cell state determining method as described in the embodiments of the third aspect.

An embodiment of this disclosure provides a computer readable medium, including a computer readable program code, which will cause a terminal equipment to carry out the cell state determining method as described in the embodiments of the third aspect.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the spirits and principle of the present disclosure, and such variants and modifications fall within the scope of the present disclosure.

As to implementations containing the above embodiments, following supplements are further disclosed.

1. A cell state determining method, applicable to a repeater, characterized in that the method including:
receiving relevant information of cell selection or reselection; and
determining whether a cell is considered as a candidate cell of the repeater in a cell selection or reselection procedure according to the relevant information of cell selection or reselection.

2. The method according to supplement 1, wherein,
the relevant information of cell selection or reselection includes cell state information and/or cell restriction information, and/or intra-frequency reselection information.

3. The method according to supplement 2, wherein,
the cell state information includes at least one of the following information:
cell state information applicable to a normal terminal equipment (user equipment);
cell state information applicable to a reduced capability terminal equipment (RedCap UE); and
cell state information applicable to an IAB or an IAB-MT;
the cell restriction information includes the following information:
cell restriction information applicable to a terminal equipment and/or an IAB-MT;
and the intra-frequency reselection information includes intra-frequency reselection information applicable to a normal terminal equipment and/or intra-frequency reselection information applicable to a RedCap UE.

4. The method according to supplement 3, wherein the cell restriction information applicable to the terminal equipment and/or the IAB-MT includes at least one of the following information: a cell reserved state for operator use (cellReservedForOperatorUse), a cell reserved state for other use (cellReservedForOtherUse), and a cell 11 reserved state for future use (cellReservedForFutureUse).

5. The method according to any one of supplements 1-4, wherein the determining whether a cell is considered as a candidate cell of the repeater in a cell selection or reselection procedure according to the relevant information of cell selection or reselection includes:
ignoring the relevant information of cell selection or reselection, and/or determining that the cell is considered as a candidate cell of the repeater in the cell selection or reselection procedure.

6. The method according to any one of supplements 1-4, wherein the determining whether a cell is considered as a candidate cell of the repeater in a cell selection or reselection procedure according to the relevant information of cell selection or reselection includes:
using the relevant information of cell selection or reselection to determine whether the cell is considered as a candidate cell of the repeater in the cell selection or reselection procedure.

7. The method according to supplement 6, wherein the using the relevant information of cell selection or reselection to determine whether the cell is considered as a candidate cell of the repeater in the cell selection or reselection procedure includes using the cell restriction information applicable to the terminal equipment and/or IAB-MT to determine whether the cell is considered as a candidate cell of the repeater in the cell selection or reselection procedure, including at least one of the following:
in a case where a state of cellReservedForOperatorUse is “reserved”, determining that the cell is considered as a candidate cell of the repeater in the cell selection or reselection procedure;
in a case where a state of cellReservedForOtherUse is “true”, determining that the cell is considered as a candidate cell of the repeater in the cell selection or reselection procedure; and
in a case where a state of cellReservedForFutureUse is “true”, determining that the cell is considered as a candidate cell of the repeater in the cell selection or reselection procedure.

8. The method according to supplement 6, wherein the using the relevant information of cell selection or reselection to determine whether the cell is considered as a candidate cell of the repeater in the cell selection or reselection procedure includes using the cell state information applicable to the IAB and/or IAB-MT to determine whether the cell is considered as a candidate cell of the repeater in the cell selection or reselection procedure, including:
when a field representing the cell state information applicable to IAB or IAB-MT is present, determining that the cell is considered as a candidate cell of the repeater in the cell selection or reselection procedure.

9. The method according to any one of supplements 1-4, wherein the relevant information of cell selection or reselection includes or does not include repeater-specific cell state information and/or cell restriction information.

10. The method according to supplement 9, wherein the repeater-specific cell state information and/or cell restriction information is/are used to indicate whether the cell is considered as a candidate cell of the repeater in the cell selection or reselection procedure; and/or,
indicate whether the cell supports the repeater; and/or,
indicate whether the cell is considered by the repeater as being barred during the cell selection or reselection procedure; and/or,
indicate whether the cell is considered by the repeater as being reserved during the cell selection or reselection procedure.

11. The method according to supplement 10, wherein,
when the relevant information of cell selection or reselection does not include the repeater-specific cell state information and/or cell restriction information, it is determined that the cell is not a candidate cell of the repeater in the cell selection or reselection procedure;
and when the relevant information of cell selection or reselection includes the repeater-specific cell state information and/or cell restriction information, it is determined that the cell is considered as a candidate cell of the repeater in the cell selection or reselection procedure;
or,
when the relevant information of cell selection or reselection includes the repeater-specific cell state information and/or cell restriction information, it is determined that the cell is not a candidate cell of the repeater in the cell selection or reselection procedure;
and when the relevant information of cell selection or reselection does not include the repeater-specific cell state information and/or cell restriction information, it is determined that the cell is considered as a candidate cell of the repeater in the cell selection or reselection procedure.

12. The method according to supplement 11, wherein,
when all relevant information matched with a first PLMN and/or a first NPN does not include the repeater-specific cell state information and/or cell restriction information, it is determined that the cell is not a candidate cell of the repeater in the cell selection or reselection procedure;
and when at least one of the relevant information matched with the first PLMN and/or the first NPN includes the repeater-specific cell state information and/or cell restriction information, it is determined that the cell is considered as a candidate cell of the repeater in the cell selection or reselection procedure;
or,
when all relevant information matched with a first PLMN and/or a first NPN does not include the repeater-specific cell state information and/or cell restriction information, it is determined that the cell is considered as a candidate cell of the repeater in the cell selection or reselection procedure;
and when at least one of the relevant information matched with the first PLMN and/or the first NPN includes the repeater-specific cell state information and/or cell restriction information, it is determined that the cell is not a candidate cell of the repeater in the cell selection or reselection procedure.

13. The method according to supplement 12, wherein the first PLMN includes:
a selected PLMN,
a registered PLMN, and
a PLMN in an equivalent PLMN list;
and the first NPN includes:
a selected SNPN,
a registered SNPN, and
an SNPN in an equivalent SNPN list.

14. The method according to supplement 9, wherein,
in a case where a system information block indicates multiple PLMNs or SNPNs,
the repeater-specific cell state information and/or cell restriction information is/are per-PLMN specific or per-NPN specific; or,
the repeater-specific cell state information and/or cell restriction information is/are common to the multiple PLMNs or SNPNs.

15. The method according to any one of supplements 1-4, wherein the relevant information of cell selection or reselection includes repeater-specific intra-frequency reselection information.

16. The method according to supplement 15, wherein the repeater-specific intra-frequency reselection information is used to indicate whether a cell at the same frequency as a barred cell is considered as a candidate cell of the repeater in the cell selection or reselection procedure, or is used to indicate whether the repeater is able to perform cell selection or reselection on a cell at the same frequency as a cell considered as being barred.

17. The method according to supplement 15, wherein the determining whether the cell is considered as a candidate cell of the repeater in the cell selection or reselection procedure according to the relevant information of cell selection or reselection includes: determining that a cell at the same frequency as a barred cell is considered as a candidate cell of the repeater in the cell selection or reselection procedure in a case where the repeater-specific intra-frequency reselection information is being allowed.

18. The method according to any one of supplements 1-17, wherein,
the relevant information of cell selection or reselection is carried by a master system information block (MIB) and/or a system information block (SIB).

19. A cell state determining method, applicable to a network device, the method including:
generating relevant information of cell selection or reselection, the relevant information of cell selection or reselection being used by a repeater to determine whether a cell is considered as a candidate cell of the repeater in a cell selection or reselection procedure; and
transmitting the relevant information of cell selection or reselection.

20. The method according to supplement 19, wherein,
the relevant information of cell selection or reselection includes cell state information and/or cell restriction information, and/or intra-frequency reselection information.

21. The method according to supplement 20, wherein,
the cell state information includes at least one of the following information:
cell state information applicable to a normal terminal equipment (user equipment);
cell state information applicable to a reduced capability terminal equipment (RedCap UE); and
cell state information applicable to an IAB or an IAB-MT;
the cell restriction information includes the following information:
cell restriction information applicable to a terminal equipment and/or an IAB-MT;
and the intra-frequency reselection information includes intra-frequency reselection information applicable to a normal terminal equipment and/or intra-frequency reselection information applicable to a RedCap UE.

22. The method according to supplement 21, wherein the cell restriction information applicable to the terminal equipment and/or the IAB-MT includes at least one of the following information: a cell reserved state for operator use (cellReservedForOperatorUse), a cell reserved state for other use (cellReservedForOtherUse), and a cell reserved state for future use (cellReservedForFutureUse).

23. The method according to supplements 19-22, wherein the relevant information of cell selection or reselection includes or does not include repeater-specific cell state information and/or cell restriction information.

24. The method according to supplement 23, wherein the repeater-specific cell state information and/or cell restriction information is/are used to indicate whether the cell is considered as a candidate cell of the repeater in the cell selection or reselection procedure; and/or,
indicate whether the cell supports the repeater; and/or,
indicate whether the cell is considered by the repeater as being barred during the cell selection or reselection procedure; and/or,
indicate whether the cell is considered by the repeater as being reserved during the cell selection or reselection procedure.

25. The method according to any one of supplements 19-22, wherein the relevant information of cell selection or reselection includes repeater-specific intra-frequency reselection information.

26. The method according to supplement 25, wherein the repeater-specific intra-frequency reselection information is used to indicate whether a cell at the same frequency as a barred cell is considered as a candidate cell of the repeater in the cell selection or reselection procedure, or is used to indicate whether the repeater is able to perform cell selection or reselection on a cell at the same frequency as a cell considered as being barred.

27. The method according to any one of supplements 19-26, wherein,
the relevant information of cell selection or reselection is carried by a master system information block (MIB) and/or a system information block (SIB).

28. A cell state determining method, applicable to a terminal equipment, the method including:
receiving relevant information of cell selection or reselection; and
ignoring repeater-specific relevant information of cell selection or reselection in the relevant information of cell selection or reselection.

29. The method according to supplement 28, wherein the repeater-specific relevant information of cell selection or reselection includes repeater-specific cell state information and/or repeater-specific cell restriction information and/or repeater-specific intra-frequency reselection information.

30. A repeater, including a memory and a processor, the memory storing a computer program, wherein the processor is configured to execute the computer program to carry out the cell state determining method described in any one of supplements 1-18.

31. A network device, including a memory and a processor, the memory storing a computer program, wherein the processor is configured to execute the computer program to carry out the cell state determining method described in any one of supplements 19-27.

32. A terminal equipment, including a memory and a processor, the memory storing a computer program, wherein the processor is configured to execute the computer program to carry out the cell state determining method described in either one of supplements 28-29.

37. A cell state determining apparatus, applicable to a repeater, characterized in that the apparatus including:
a receiving unit configured to receive relevant information of cell selection or reselection; and
a determining unit configured to determine whether a cell is considered as a candidate cell of the repeater in a cell selection or reselection procedure according to the relevant information of cell selection or reselection.

38. The apparatus according to supplement 37, wherein, the relevant information of cell selection or reselection includes cell state information and/or cell restriction information, and/or intra-frequency reselection information.

39. The apparatus according to supplement 38, wherein,
the cell state information includes at least one of the following information:
cell state information applicable to a normal terminal equipment (user equipment);
cell state information applicable to a reduced capability terminal equipment (RedCap UE); and
cell state information applicable to an IAB or an IAB-MT;
the cell restriction information includes the following information:
cell restriction information applicable to a terminal equipment and/or an IAB-MT;
and the intra-frequency reselection information includes intra-frequency reselection information applicable to a normal terminal equipment and/or intra-frequency reselection information applicable to a RedCap UE.

40. The apparatus according to supplement 39, wherein the cell restriction information applicable to the terminal equipment and/or the IAB-MT includes at least one of the following information: a cell reserved state for operator use (cellReservedForOperatorUse), a cell reserved state for other use (cellReservedForOtherUse), and a cell reserved state for future use (cellReservedForFutureUse).

41. The apparatus according to any one of supplements 37-40, wherein the determining unit includes:
a first determining module configured to ignore the relevant information of cell selection or reselection, and/or determine that the cell is considered as a candidate cell of the repeater in the cell selection or reselection procedure.

42. The apparatus according to any one of supplements 37-40, wherein the determining unit further includes:
a second determination module configured to use the relevant information of cell selection or reselection to determine whether the cell is considered as a candidate cell of the repeater in the cell selection or reselection procedure.

43. The apparatus according to supplement 42, wherein that the second determining module uses the cell restriction information applicable to the terminal equipment and/or IAB-MT to determine whether the cell is considered as a candidate cell of the repeater in the cell selection or reselection procedure includes at least one of the following:
in a case where a state of cellReservedForOperatorUse is “reserved”, the second determining module determines that the cell is considered as a candidate cell of the repeater in the cell selection or reselection procedure;
in a case where a state of cellReservedForOtherUse is “true”, the second determining module determines that the cell is considered as a candidate cell of the repeater in the cell selection or reselection procedure; and
in a case where a state of cellReservedForFutureUse is “true”, the second determining module determines that the cell is considered as a candidate cell of the repeater in the cell selection or reselection procedure.

44. The apparatus according to supplement 42, wherein when a field representing the cell state information applicable to IAB or IAB-MT is present, the second determining module determines that the cell is considered as a candidate cell of the repeater in the cell selection or reselection procedure.

45. The apparatus according to any one of supplements 37-40, wherein the relevant information of cell selection or reselection includes or does not include repeater-specific cell state information and/or cell restriction information.

46. The apparatus according to supplement 45, wherein the repeater-specific cell state information and/or cell restriction information is/are used to indicate whether the cell is considered as a candidate cell of the repeater in the cell selection or reselection procedure; and/or,
indicate whether the cell supports the repeater; and/or,
indicate whether the cell is considered by the repeater as being barred during the cell selection or reselection procedure; and/or,
indicate whether the cell is considered by the repeater as being reserved during the cell selection or reselection procedure.

47. The apparatus according to supplement 46, wherein the determining unit includes:
a third determining module configured to determine that the cell is not a candidate cell of the repeater in the cell selection or reselection procedure when the relevant information of cell selection or reselection does not include the repeater-specific cell state information and/or cell restriction information;
and determine that the cell is considered as a candidate cell of the repeater in the cell selection or reselection procedure when the relevant information of cell selection or reselection includes the repeater-specific cell state information and/or cell restriction information;
or,
a fourth determining module configured to determine that the cell is not a candidate cell of the repeater in the cell selection or reselection procedure when the relevant information of cell selection or reselection includes the repeater-specific cell state information and/or cell restriction information;
and determine that the cell is considered as a candidate cell of the repeater in the cell selection or reselection procedure when the relevant information of cell selection or reselection does not include the repeater-specific cell state information and/or cell restriction information.

48. The apparatus according to supplement 47, wherein,
the third determining module determines that the cell is not a candidate cell of the repeater in the cell selection or reselection procedure when all relevant information matched with a first PLMN and/or a first NPN does not include the repeater-specific cell state information and/or cell restriction information;
and the third determining module determines that the cell is considered as a candidate cell of the repeater in the cell selection or reselection procedure when at least one of the relevant information matched with the first PLMN and/or the first NPN includes the repeater-specific cell state information and/or cell restriction information;
or,
the fourth determining module determines that the cell is considered as a candidate cell of the repeater in the cell selection or reselection procedure when all relevant information matched with a first PLMN and/or a first NPN does not include the repeater-specific cell state information and/or cell restriction information;
and the fourth determining module determines that the cell is not a candidate cell of the repeater in the cell selection or reselection procedure when at least one of the relevant information matched with the first PLMN and/or the first NPN includes the repeater-specific cell state information and/or cell restriction information.

49. The apparatus according to supplement 48, wherein,
the first PLMN includes:
a selected PLMN,
a registered PLMN, and
a PLMN in an equivalent PLMN list;
and the first NPN includes:
a selected SNPN,
a registered SNPN, and
an SNPN in an equivalent SNPN list.

50. The apparatus according to supplement 45, wherein,
in a case where a system information block indicates multiple PLMNs or SNPNs,
the repeater-specific cell state information and/or cell restriction information is/are per-PLMN specific or per-NPN specific; or,
the repeater-specific cell state information and/or cell restriction information is/are common to the multiple PLMNs or SNPNs.

51. The apparatus according to any one of supplements 37-40, wherein the relevant information of cell selection or reselection includes repeater-specific intra-frequency reselection information.

52. The apparatus according to supplement 51, wherein the repeater-specific intra-frequency reselection information is used to indicate whether a cell at the same frequency as a barred cell is considered as a candidate cell of the repeater in the cell selection or reselection procedure, or is used to indicate whether the repeater is able to perform cell selection or reselection on a cell at the same frequency as a cell considered as being barred.

53. The apparatus according to supplement 51, wherein the determining unit includes:
a fifth determining module configured to determine that a cell at the same frequency as a barred cell is considered as a candidate cell of the repeater in the cell selection or reselection procedure in a case where the repeater-specific intra-frequency reselection information is being allowed.

54. The apparatus according to any one of supplements 37-53, wherein,
the relevant information of cell selection or reselection is carried by a master system information block (MIB) and/or a system information block (SIB).

55. A cell state determining apparatus, applicable to a network device, the apparatus including:
a generating unit configured to generate relevant information of cell selection or reselection, the relevant information of cell selection or reselection being used by a repeater to determine whether a cell is considered as a candidate cell of the repeater in a cell selection or reselection procedure; and
a transmitting unit configured to transmit the relevant information of cell selection or reselection.

56. A cell state determining apparatus, applicable to a terminal equipment, the apparatus including:
a receiving unit configured to receive relevant information of cell selection or reselection; and
a determining unit configured to ignore repeater-specific relevant information of cell selection or reselection in the relevant information of cell selection or reselection.

57. A communication system, including:
the repeater as described in supplement 30, and/or
the network device as described in supplement 31, and/or
the terminal equipment as described in supplement 32.

1. A cell state determining apparatus, applicable to a Network-Controlled repeater (NCR), the apparatus comprising:
a receiver configured to receive relevant information of cell selection or reselection, and
processor circuitry configured to consider a cell as a candidate for cell selection for Network-Controlled repeater according to the relevant information of cell selection or reselection, and/or, ignore the relevant information of cell selection or reselection.

2. The apparatus according to claim 1, wherein,
the relevant information of cell selection or reselection includes cell state information and/or cell restriction information, and/or intra-frequency reselection information.

3. The apparatus according to claim 2, wherein,
the relevant information of cell selection or reselection is carried by a master system information block (MIB) and/or a system information block (SIB).

4. The apparatus according to claim 3, wherein,
the cell state information includes at least one of the following information:
cell state information applicable to a terminal equipment (user equipment);
the cell restriction information includes the following information:
cell restriction information applicable to a terminal equipment and/or an IAB-MT;
and the intra-frequency reselection information includes intra-frequency reselection information applicable to a terminal equipment.

5. The apparatus according to claim 4, wherein the cell restriction information applicable to the terminal equipment and/or the IAB-MT includes at least one of the following information: a cell reserved state for operator use (cellReservedForOperatorUse), a cell reserved state for other use (cellReservedForOtherUse), and a cell reserved state for future use (cellReservedForFutureUse).

6. The apparatus according to claim 4, wherein,
the processor circuitry is configured to ignore a field of cellBarred in the master system information block (MIB).

7. The apparatus according to claim 5, wherein,
the processor circuitry is configured to ignore a field of cellReservedForOperatorUse and/or a field of cellReservedForOtherUse and/or a field of cellReservedForFutureUse in the system information block (SIB).

8. The apparatus according to claim 4, wherein,
the processor circuitry is configured to ignore intra-frequency reselection information in the master system information block (MIB).

9. The apparatus according to claim 1, wherein the relevant information of cell selection or reselection includes or does not include repeater-specific cell state information and/or cell restriction information.

10. The apparatus according to claim 9, wherein the repeater-specific cell state information and/or cell restriction information is used to indicate whether the cell is considered as a candidate for cell (re) selection for Network-Controlled repeater; and, indicate whether the cell supports the Network-Controlled repeater.

11. The apparatus according to claim 10, wherein the repeater-specific cell state information and/or cell restriction information is contained in a field in a system information block 1 (SIB1).

12. The apparatus according to claim 11, wherein the field combines both the support of NCR and the cell status for NCR, if the field is present, the cell supports NCR and the cell is also considered as a candidate for cell (re) selection for NCRs, if the field is absent, the cell does not support NCR and/or the cell is barred for NCR.

13. The apparatus according to claim 12, wherein,
the processor circuitry is configured to consider a cell as a candidate for cell selection if the system information block (SIB) broadcasted by the cell indicates NCR support.

14. The apparatus according to claim 9, wherein,
in a case multiple PLMNs or NPNs indicated in a system information block 1 (SIB1),
the repeater-specific cell state information and/or cell restriction information is common to the multiple PLMNs or NPNs.

15. A cell state determining apparatus, applicable to a network device, the apparatus including:
processor circuitry configured to generate relevant information of cell selection or reselection, wherein the relevant information of cell selection or reselection being used by a Network-Controlled repeater (NCR) to consider a cell as a candidate for cell selection, and/or, the relevant information of cell selection or reselection being ignored by a Network-Controlled repeater (NCR); and
a transmitter configured to transmit the relevant information of cell selection or reselection.

16. The apparatus according to claim 15, wherein the relevant information of cell selection or reselection includes or does not include repeater-specific cell state information and/or cell restriction information.

17. The apparatus according to claim 16, wherein the repeater-specific cell state information and/or cell restriction information is used to indicate whether the cell is considered as a candidate for cell (re) selection for Network-Controlled repeater; and, indicate whether the cell supports the Network-Controlled repeater.

18. The apparatus according to claim 16, wherein the repeater-specific cell state information and/or cell restriction information is contained in a field in a system information block 1 (SIB1).

19. The apparatus according to claim 18, wherein the field combines both the support of NCR and the cell status for NCR, if the field is present, the cell supports NCR and the cell is also considered as a candidate for cell (re) selection for NCRs, if the field is absent, the cell does not support NCR and/or the cell is barred for NCR.

20. The apparatus according to claim 19, wherein,
the processor circuitry is configured to consider a cell as a candidate for cell selection if the system information block (SIB) broadcasted by the cell indicates NCR support.
